(19) United States
(12) Patent Application Publication
(10) Pub. No.: US 2025/0041722 A1
(43) Pub. Date: Feb. 6, 2025

(54) COMPUTER-READABLE NON-TRANSITORY STORAGE MEDIUM HAVING GAME PROGRAM STORED THEREIN, GAME SYSTEM, AND GAME PROCESSING METHOD

(71) Applicant: NINTENDO CO., LTD., Kyoto (JP)

(72) Inventors: Hajime NAKAO, Kyoto (JP); Mahito IDEHARA, Kyoto (JP)

(21) Appl. No.: 18/749,218

(22) Filed: Jun. 20, 2024

(30) Foreign Application Priority Data
Aug. 2, 2023 (JP) 2023-126240

(51) Int. Cl. A63F 13/52; A63F 13/35; A63F 13/48

(52) U.S. Cl. CPC A63F 13/52; A63F 13/35; A63F 13/48

(57) ABSTRACT

A first game apparatus and a second game apparatus are matched via a network. A first player character to be operated by a player of the first game apparatus and a second player character to be operated by a player of the second game apparatus are selected from a character group including a plurality of characters different from each other. In a case where the selected characters are different characters, the first game apparatus and the second game apparatus both draw a game space including the first player character and the second player character. On the other hand, in a case where the selected characters are the same character, the first game apparatus draws a game space without drawing the second player character, and the second game apparatus draws a game space without drawing the first player character.

### CROSS REFERENCE TO RELATED APPLICATION

This application claims priority to Japanese Patent Application No. 2023-126240 filed on Aug. 2, 2023, the entire contents of which are incorporated herein by reference.

### FIELD

The present disclosure relates to multiplay game processing.

### BACKGROUND AND SUMMARY

To date, there have been such games that a plurality of players play in a game stage. Among such games, there is also known an online multiplay game which is played by a plurality of players via a network such as the Internet.

In some games, e.g., a competitive fighting game, a player plays by selecting a character that the player operates, from a plurality of kinds of characters prepared in advance. In a game of such a type that a player plays by selecting a character, in a case of performing online multiplay with may unspecified competitors, the own character selected by the player might be the same as a character selected by another player. In this case, a plurality of the same characters are displayed on the same game screen, so that the own character operated by each player might not be distinguishable.

In view of the above circumstances, configuration examples will be shown below.

### Configuration 1

A configuration 1 is a game system including a processor and a memory coupled thereto, and configured to perform a multiplay game among players of a plurality of game apparatuses matched via a network, the game system including: a first game apparatus; and a second game apparatus connected to the first game apparatus via the network. A processor of the first game apparatus selects a first player character to be subjected to movement control based on an operation by the player of the first game apparatus, from a character group including a plurality of characters different from each other. A processor of the second game apparatus selects a second player character to be subjected to movement control based on an operation by the player of the second game apparatus, from the character group. In a case where the selected first player character and the selected second player character are different characters, the processor of the first game apparatus draws a game space including the first player character and the second player character, and the processor of the second game apparatus draws a game space including the first player character and the second player character. In a case where the selected first player character and the selected second player character are the same character, the processor of the first game apparatus draws a game space including the first player character without drawing the second player character, while keeping the matching between the first game apparatus and the second game apparatus, and the processor of the second game apparatus draws a game space including the second player character without drawing the first player character, while keeping the matching between the first game apparatus and the second game apparatus.

According to the above configuration, in a game of such a type that an own character to be used is selected from a predetermined character group, a character of another player coinciding with a character selected by a player of each game apparatus is not displayed on the game apparatus. Thus, on a screen displayed on each individual game apparatus, it becomes easy to recognize the own character to be operated by the player.

### Configuration 2

In configuration 2 based on the above configuration 1, the game system may further include a third game apparatus. A processor of the third game apparatus may select a third player character to be subjected to movement control based on an operation by the player of the third game apparatus, from the character group. In a case where the selected third player character is a character different from the first player character and is the same character as the second player character, the processor of the first game apparatus may draw the game space including only one of the second player character and the third player character.

According to the above configuration, in a case where the own character selected by the player does not coincide with any characters but characters selected by other players coincide with each other, only one of the coinciding characters is displayed. Thus, for example, in a case of desiring to perform multiplay without displaying coinciding characters, it is unnecessary to perform control for performing matching so that characters will not coincide with each other. That is, in matching, coincidence of characters need not be considered and therefore a matching waiting time can be shortened. In addition, each player can select a desired character to play, without being restricted in selection of characters.

### Configuration 3

In configuration 3 based on the above configuration 2, the processor of the first game apparatus may draw the game space in which, of the second player character and the third player character, a character whose position in the game space is closer to the first player character is included and the other character is not included.

According to the above configuration, since a character of another player is displayed near the own operated character, it becomes easy to communicate with the other player via characters.

### Configuration 4

In configuration 4 based on the above configuration 3, after the game space including only one of the second player character and the third player character is drawn, determination for a positional relationship between the first player character and each of the second player character and the third player character in the game space, may be performed at predetermined-period intervals, and as a result of the determination, if a character present at a position closest to the first player character has changed, the game space in which the character present at the closest position is included and the other character is not included, may be drawn.

According to the above configuration, since determination for the positional relationship is performed at predetermined time intervals, display of coinciding characters of other players can be prevented from being switched frequently.

### Configuration 5

In configuration 5 based on the above configuration 2, in a case where a non-operation state in which the player of the second game apparatus or the player of the third game apparatus is not performing operation has continued for a predetermined period or longer, the processor of the first game apparatus may draw the game space in which the player character of the player in the non-operation state is not included, irrespective of a positional relationship with the first player character.

According to the above configuration, another player character that has not been operated for a certain period is not displayed. Thus, it is possible to prevent the player from taking an effort to communicate with the character of the other player with whom the player is less likely to succeed in communicating.

### Configuration 6

In configuration 6 based on the above configuration 1, the game space may include a stage space in which a first predetermined number of players are allowed to join by the matching, and a world space in which a second predetermined number of players more than the first predetermined number are allowed to join by the matching and each player is allowed to select the stage to play. In drawing the world space on the first game apparatus, the world space including the first player character may be drawn such that the second player character is not drawn, in a case where the second player character is the same as the first player character. In drawing the stage space on the first game apparatus, the stage space including the first player character and the second player character may be drawn such that the second player character is replaced with a character different from the first player character, in a case where the second player character is the same as the first player character.

According to the above configuration, on a game screen of a world space, a

plurality of the same characters as the own character used by the player are prevented from being displayed, whereby it is possible to avoid such a situation that it is difficult to recognize the own operation target. In addition, on a game screen of a stage space in which the number of participants is likely to be small as compared to that in the world space, a sense of multiplay by a plurality of players can be ensured while such a situation that it is difficult to recognize the own operation target is avoided.

According to the present disclosure, it is possible to suppress occurrence of a matching waiting state due to coincidence of characters, while avoiding such a situation that it is difficult to recognize the own character operated by the player.

### BRIEF DESCRIPTION OF THE DRAWINGS

FIG. 1 is a schematic diagram showing a non-limiting example of the entire configuration of a game system according to the exemplary embodiment;

FIG. 2 is a block diagram showing a non-limiting example of the hardware configuration of a game server 1;

FIG. 3 is a block diagram showing a non-limiting example of the hardware configuration of a game apparatus 3;

FIG. 4 shows a non-limiting example of a game screen;

FIG. 5 shows a non-limiting example of a game screen;

FIG. 6 shows a non-limiting example of a game screen;

FIG. 7 shows a non-limiting example of a game screen;

FIG. 8 shows a non-limiting example of panels;

FIG. 9 shows a non-limiting example of a positional relationship in a world;

FIG. 10 shows a non-limiting example of a game screen;

FIG. 11 shows a non-limiting example of a game screen;

FIG. 12 shows a non-limiting example of a game screen;

FIG. 13 shows a non-limiting example of a game screen;

FIG. 14 shows a non-limiting example of a positional relationship in a world;

FIG. 15 shows a non-limiting example of a game screen;

FIG. 16 shows a non-limiting example of a game screen;

FIG. 17 shows a non-limiting example of a game screen;

FIG. 18 shows a non-limiting example of a game screen;

FIG. 19 shows a non-limiting example of a game screen;

FIG. 20 shows a non-limiting example of a game screen;

FIG. 21 shows a non-limiting example of a message;

FIG. 22 shows a non-limiting example of a message;

FIG. 23 is a memory map showing a non-limiting example of various data stored in a storage section 12 of the game server;

FIG. 24 shows a non-limiting example of the data structure of world room management data 304;

FIG. 25 shows a non-limiting example of the data structure of world entered player information 314;

FIG. 26 shows a non-limiting example of the data structure of stage room management data 305;

FIG. 27 shows a non-limiting example of the data structure of replay management data 306;

FIG. 28 is a memory map showing a non-limiting example of various data stored in a storage section 32 of the game apparatus 3;

FIG. 29 shows a non-limiting example of the data structure of player character master data 404;

FIG. 30 shows a non-limiting example of the data structure of placement article master data 405;

FIG. 31 shows a non-limiting example of the data structure of display target management data 410;

FIG. 32 shows a non-limiting example of the data structure of remote player data 413;

FIG. 33 shows a non-limiting example of the data structure of player actor management data 415;

FIG. 34 shows a non-limiting example of the data structure of placement article management data 416;

FIG. 35 is a non-limiting example of a flowchart showing the details of a world map process executed by the game apparatus 3;

FIG. 36 is a non-limiting example of a flowchart showing the details of the world map process executed by the game apparatus 3;

FIG. 37 is a non-limiting example of a flowchart showing the details of a display target determination process;

FIG. 38 is a non-limiting example of a flowchart showing the details of a stage play process;

FIG. 39 is a non-limiting example of a flowchart showing the details of the stage play process;

FIG. 40 is a non-limiting example of a flowchart showing the details of a character disguise determination process;

FIG. 41 is a non-limiting example of a flowchart showing the details of a placement article disguise process;

FIG. 42 is a non-limiting example of a flowchart showing the details of an entry/exit checking process;

FIG. 43 is a non-limiting example of a flowchart showing the details of the entry/exit checking process;

FIG. 44 is a non-limiting example of a flowchart showing the details of a ghost placement process;

FIG. 45 is a non-limiting example of a flowchart showing the details of a placement process; and

FIG. 46 is a flowchart showing the details of a game server process executed by the game server 1.

### DETAILED DESCRIPTION OF NON-LIMITING EXAMPLE EMBODIMENTS

Hereinafter, one exemplary embodiment of the present disclosure will be described. FIG. 1 is a schematic diagram showing the entire configuration of an information processing system (game system) according to the exemplary embodiment. An information processing system 100 of the exemplary embodiment includes a game server 1 and a plurality of information processing terminals 3. The game server 1 and each information processing terminal 3 are configured to be able to communicate with each other via a network 10 such as the Internet. In the exemplary embodiment, with such a configuration, information processing is executed. Hereinafter, a description will be given with game processing as an example of the information processing. Specifically, it is assumed as an example that a game program is installed on the information processing terminal 3 and the game processing is executed while the information processing terminal 3 is communicating with the game server 1 as necessary.

### Hardware Configuration of Game Server

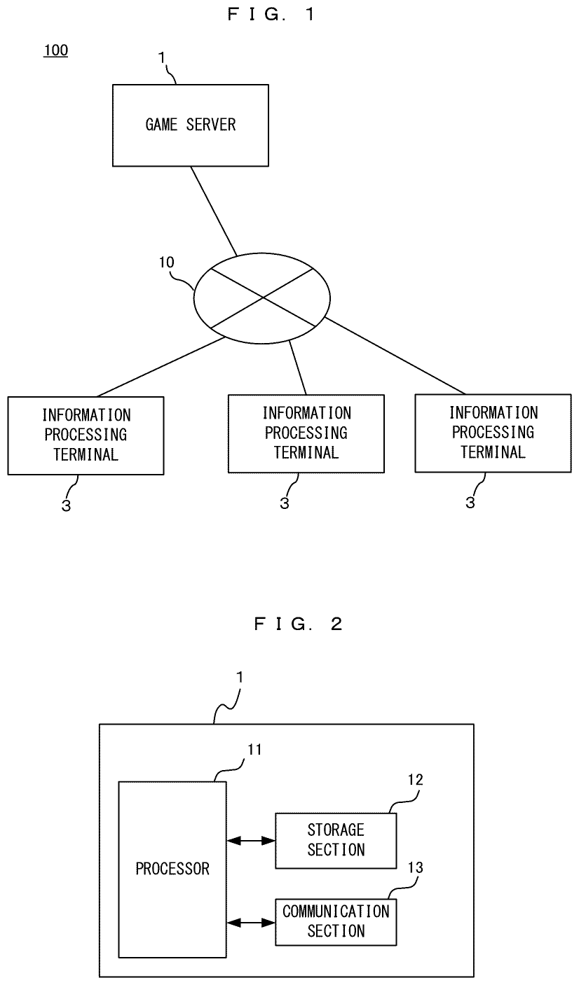

Next, the hardware configuration of the game server 1 will be described. FIG. 2 is a block diagram illustrating the hardware configuration of the game server 1. The game server 1 includes at least a processor 11, a storage section 12, and a communication section 13. The processor 11 executes various programs for controlling the game server 1. In the storage section 12, various programs to be executed by the processor 11 and various kinds of data to be used by the processor 11 are stored. The communication section 13 connects to a network by means of wired or wireless communication and transmits/receives predetermined data to/from each information processing terminal 3 or another server. In the exemplary embodiment, the case where there is one game server 1 is shown. However, a server group may be formed for performing distributed processing.

### Hardware Configuration of Game Apparatus

Next, the information processing terminal 3 will be described. The information processing terminal 3 is, for example, a smartphone, a stationary or hand-held game apparatus, a tablet terminal, a mobile phone, a personal computer, a wearable terminal, or the like. In the exemplary embodiment, a stationary game apparatus (hereinafter, referred to simply as a game apparatus) will be described as an example of the information processing terminal 3.

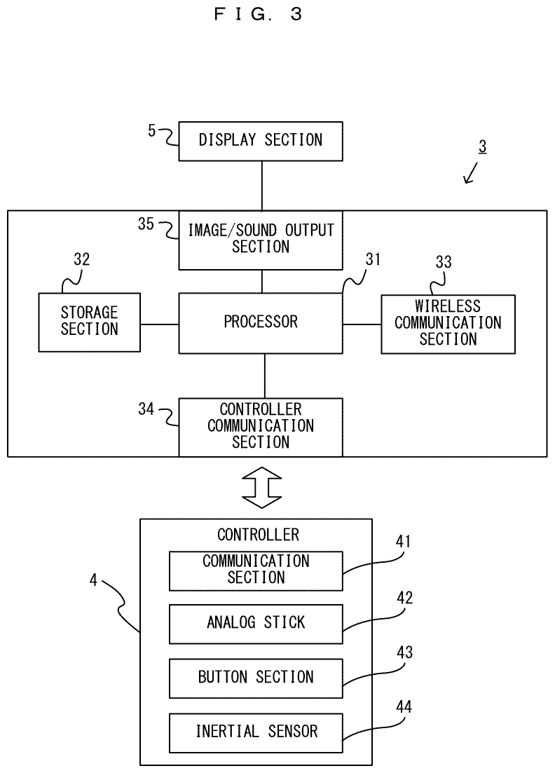

FIG. 3 is a block diagram showing an example of the hardware configuration of a game apparatus 3 according to the exemplary embodiment. In FIG. 3, the game apparatus 3 includes a processor 31. The processor 31 is an information processing section for executing various types of information processing to be executed by the game apparatus 3. For example, the processor 21 may be composed only of a CPU (Central Processing Unit), or may be composed of a SoC (System-on-a-chip) having a plurality of functions such as a CPU function and a GPU (Graphics Processing Unit) function. The processor 31 performs the various types of information processing by executing an information processing program (e.g., a game program) stored in a storage section 32. The storage section 32 may be, for example, an internal storage medium such as a flash memory and a dynamic random access memory (DRAM), or may be configured to utilize an external storage medium mounted to a slot that is not shown, or the like.

The game apparatus 3 also includes a wireless communication section 33 for the game apparatus 3 to perform wireless communication with another game apparatus 3 or the server. As this wireless communication, for example, internet communication or short-range wireless communication is used.

The game apparatus 3 also includes a controller communication section 34 for the game apparatus 3 to perform wired or wireless communication with a controller 4.

Moreover, a display section 5 (for example, a television or the like) is connected

to the game apparatus 3 via an image/sound output section 35. The processor 31 outputs an image and sound generated by, for example, executing the above information processing, to the display section 5 via the image/sound output section 35.

Next, the controller 4 will be described. The controller 4 includes at least one analog stick 42 which is an example of a direction input device. The analog stick 42 can be used as a direction input section with which a direction can be inputted. By tilting the analog stick 42, a user is allowed to input a direction corresponding to the tilt direction (also input a magnitude corresponding to the tilt angle). In addition, the controller 4 includes a button section 43 including various operation buttons. For example, the controller 4 may include a plurality of operation buttons on a main surface of the housing.

Moreover, the controller 4 includes an inertial sensor 44. Specifically, the controller 4 includes an acceleration sensor and an angular velocity sensor as the inertial sensor 44. In the exemplary embodiment, the acceleration sensor detects the magnitudes of accelerations along predetermined three axial directions. In addition, the angular velocity sensor detects angular velocities about predetermined three axes.

The controller 4 also includes a communication section 41 for performing wired or wireless communication with the controller communication section 34. The content of a direction inputted to the analog stick 42, information indicating the press state of the button section 43, and various detection results by the inertial sensor 44 are repeatedly outputted to the communication section 41 and transmitted to the game apparatus 3 at appropriate timings.

### Outline of Information Processing in Exemplary Embodiment

Next, the outline of information processing according to the exemplary embodiment will be described. In the exemplary embodiment, as an example of information processing, game processing that allows a player to play while operating a player character object (hereinafter, referred to as player character) present in a virtual space, is assumed. More specifically, in the exemplary embodiment, a side-scrolling action game (hereinafter, referred to as this game) is assumed. In this game, a two-dimensional virtual space called a “stage”, which serves as a main field for play, is prepared. In the stage, a start point and a goal point are set. Between the start point and the goal point, various enemy characters, various obstacles, and various gimmicks such as a trampoline and a pit, are arranged. This game is such a game that a player character is operated to reach the goal point while defeating or avoiding enemy characters and the like. The stage may be called a “course”, a “round”, or the like, depending on games. In the exemplary embodiment, a game screen is displayed as a two-dimensional screen. However, in another exemplary embodiment, the virtual space may be a three-dimensional virtual space and a three-dimensional screen based on a first-person view, a third-person view, or the like may be displayed.

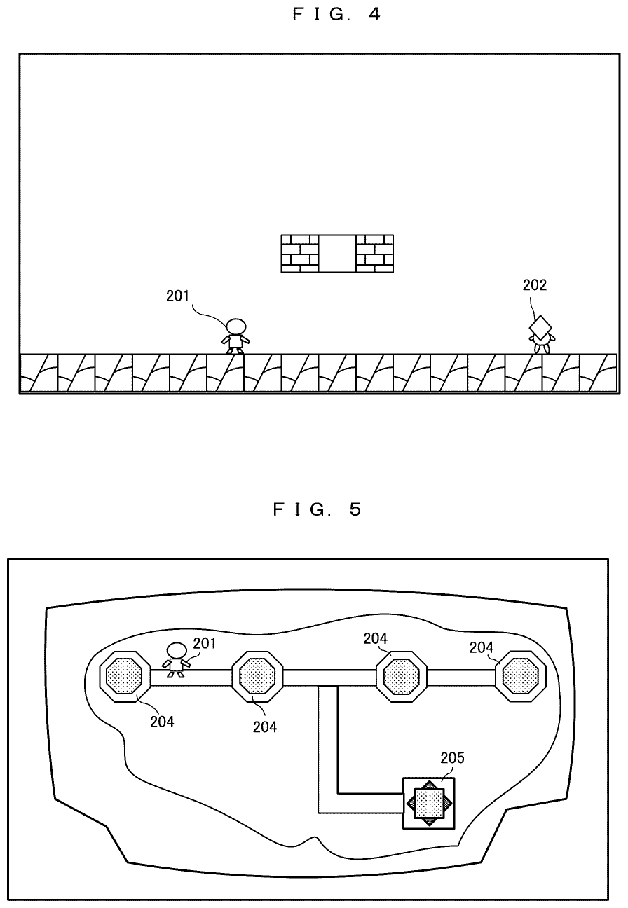

FIG. 4 shows an example of a game screen (hereinafter, referred to as stage screen) during play in the stage. The game screen shown in FIG. 4 is a screen example at a location near a start point, i.e., just after play in the stage is started. In FIG. 4, a player character 201 and an enemy character 202 are displayed. In addition, various terrain objects such as block objects are displayed. In this stage, the start point is set near the left end of the stage, and a goal point is set near the right end of the stage. Thus, the stage is configured such that the player character 201 is moved rightward in the screen through overall game progress. On this stage screen, the player performs operation to move the player character 201 toward the goal point. As the player character moves, another place in the stage is to be displayed on the stage screen. Then, when the player character has reached the goal point, the stage is cleared.

In the stage, a “midway point” is set at a substantially middle position between the start point and the goal point. At the midway point, a midway point object indicating that its location is the midway point is placed. Once the player character contacts with the midway point object, if the player character has ended up restarting during play before reaching the goal, the player character can restart from the midway point. If the player character has not reached the midway point yet, the player character restarts from the start point. The position to be set as the midway point is not limited to a substantially middle position between the start point and the goal point, and may be set at any appropriate position along the way from the start point to the goal point.

### World Map

In this game, a plurality of such stages as described above are prepared. Prior to play in each stage, a screen called a “world map screen”, which has a function of allowing the player to select a stage to play, is displayed. FIG. 5 shows an example of the world map screen. In FIG. 5, a screen showing a “world” which is a virtual space as seen from above is displayed. The virtual space may be a two-dimensional space or a three-dimensional space. A drawing method and a display manner may be different between a “world” and a “stage”. For example, a stage may be drawn by being projected through orthogonal projection from the front direction, and a world may be drawn by being imaged from above as an overhead view. In the world, a plurality of stage objects 204 serving as entrances to the stages are placed. In addition, a portal object 205 for transferring to another world is placed. In the world map screen, the player character 201 is also displayed. By operating the controller 4, the player can move the player character 201 on the world map screen. In addition, by moving the player character 201 so as to contact with any of the stage objects 204, the player can select the stage corresponding to the stage object 204. Then, by performing a predetermined operation (hereinafter, referred to as stage start operation) for starting play in the stage, the player can start play in the stage corresponding to the stage object 204. Specifically, when the stage start operation is performed, a predetermined representation is displayed and then the screen shifts to a stage screen on which the player character 201 is placed at the start point in the stage.

### Relationship Between World and Stage

In this game, also for the “world” described above, a plurality of worlds are prepared. In this game, as an example, it is assumed that there are five worlds (worlds 1 to 5) and each world includes four stages. One of the five worlds is displayed as the world map screen.

In a case of transferring from one world to another world, first, the player moves the player character 201 onto the portal object 205 in the world map screen. Then, by performing a predetermined operation (hereinafter, referred to as world transfer operation), the player can transfer the player character to another world associated with the portal object 205. For example, if, on the world map screen of the world 1, the world transfer operation is performed on the portal object 205 associated with the world 2, the player character transfers to the world 2 and the screen shifts to a world map screen corresponding to the world 2.

Flow of basic game progress in this game is as follows: the player selects a stage to play, on the world map screen, and clears the stage, thereby releasing an unreleased stage. Then, when all stages in the world are cleared, the next world is released. While clearing stages in each world, the player releases a world one after another, aiming at clearing a final stage in a final world.

### Online Play Feature

In this game, multiplay is also possible. As an example, in this game, the player can play with another player by connecting to another game apparatus 3 or the server via the Internet.

Hereinafter, an online multiplay feature of this game will be described. First, the entire network configuration will be briefly described. Basically, the network configuration is as shown in FIG. 1. In this game, a communication group configuration for an online game of a so-called MO (Multiplayer Online) type is adopted. Specifically, a communication group (hereinafter, world room) corresponding to each world and a communication group (hereinafter, referred to as stage room) corresponding to each stage are generated and managed as appropriate. In other words, virtual spaces corresponding to a world room and a stage room are prepared, and a predetermined number of players matched by the game server 1 are connected to the virtual spaces.

For each room, a maximum value of the number of persons who can enter the room is set. As an example, in this game, up to 30 persons can enter each of the world rooms. In addition, up to four persons can enter each of the stage rooms. In this game, rooms are separate on a world basis and on a stage basis, and a plurality of rooms can exist in parallel for both of world rooms and stage rooms. In this game, as an example, a connection manner of communicating through the server (client-server system) is used for the world room, and a manner of connecting the game apparatuses 3 to each other by a P2P (Peer to peer) connection method is used for the stage room.

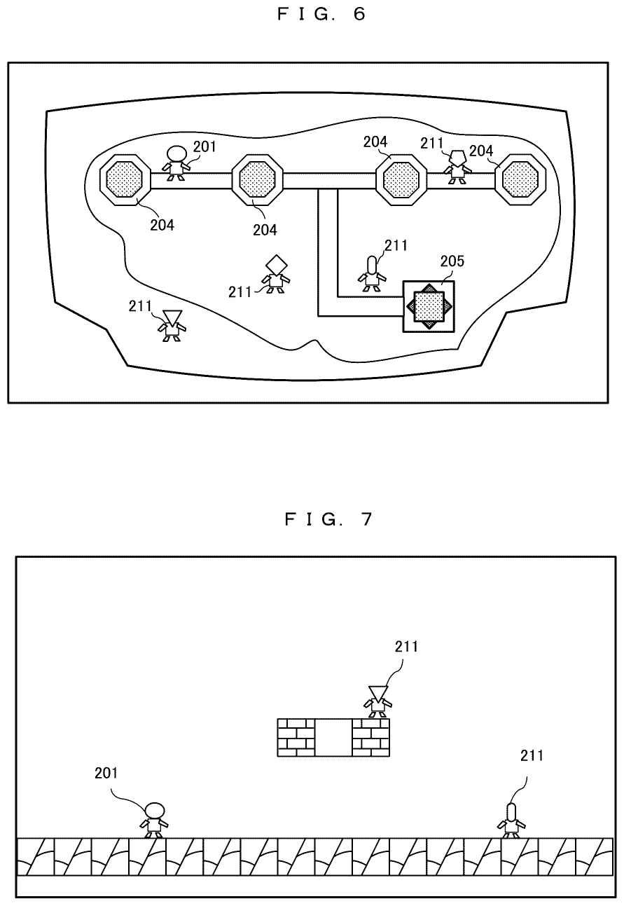

FIG. 6 shows an example of a world map screen when the player has entered a world room in which a predetermined number of players are already present. On this screen, the player character 201 and a plurality of other player characters 211 operated by other players who are in the same world room, are displayed.

FIG. 7 shows an example of a stage screen outputted from the game apparatus 3 of the player when the player has entered a stage room in which other players are already present. In FIG. 7, other player characters 211 operated by other players are displayed on the stage screen in the game apparatus 3 operated by the player. The other players entered prior to the player and started play in the stage. Thus, the other player characters 211 are present at positions slightly advanced from a start point toward a goal point.

In the following description, another player who has entered the same world room or the same stage room is referred to as a “remote player”, and another player character 211 operated by the remote player is referred to as a “remote character”. In contrast to the remote player, the player for the game apparatus 3 may be referred to as a “local player”, and the player character 201 operated by the local player may be referred to as a “local character”. In addition, as a player character related to the remote player in play in the stage, a “replay ghost” can also appear. Hereinafter, the local character, the remote character, and the replay ghost may be collectively referred to as “player actors”. In this game, regarding stage rooms, four persons can enter each room, and therefore four player actors at maximum can exist at the same time in each room. On the other hand, regarding world rooms, thirty persons at maximum can enter each room, and therefore thirty player actors at maximum, including the local character and the remote characters, can exist. However, the number of player characters displayed at the same time is twelve at maximum, as described above.

### Replay Ghost

Next, the replay ghost which appears in stage play will be described. The replay ghost is for reproducing replay data of another player as a ghost. Therefore, in principle, the outer appearance of the replay ghost represents the character used when recorded for replay (in some cases, the outer appearance can become a “disguised character” described later).

In the exemplary embodiment, play from the midway point to the goal point is stored as replay data in the game server 1. Then, when a predetermined condition is satisfied, the replay ghost appears. The predetermined condition is, specifically, that the player character advances to the midway point in a state in which only one local player 1 is in the stage room. That is, in a case where the player character has advanced to the midway point without the player being matched with another player, replay data is downloaded from the game server 1 and is reproduced. Thus, another player character based on replay data can be displayed as a ghost.

### Placement Article Object

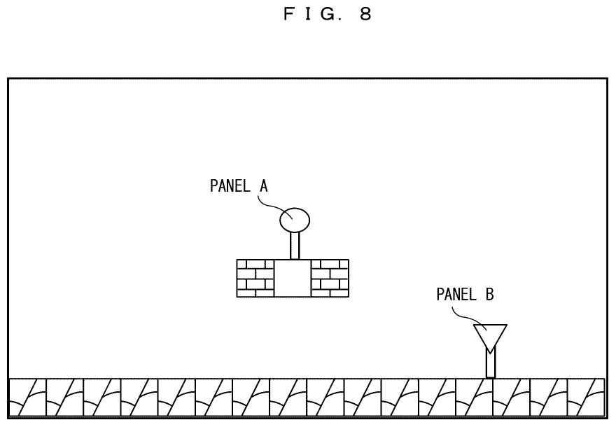

Each player can place a predetermined placement article object in a stage by performing a predetermined operation during play in the stage. The placement article object is an object that can provide an advantageous effect to the player, for example. For example, the placement article object is an item or a panel-shaped object (hereinafter, simply referred to as panel). In a case of an item, it is possible to acquire an item placed by another player, by bringing the player character into contact with the item. This allows items to be passed and received between players. In a case of a panel, it is possible to provide an advantageous effect such as upgrading the player character or eliminating a disadvantageous status (status ailment, etc.) occurring in the player character, when the player character contacts with the panel. That is, by placing the panel, it is also possible to indirectly help another player. In the exemplary embodiment, as the outer appearance of a placement article object, an image corresponding to a player character that places the placement article object is prepared. FIG. 8 shows an example of the panels. In FIG. 8, a panel A placed by a character A which is a local character, and a panel B placed by a character B which is a remote character, are shown as an example. Both panels are treated as the same placement article objects in terms of a function, but as shown in FIG. 8, the outer appearances thereof are different and they are designed so as to allow each player to distinguish which player character placed the panel. Regarding a certain kind of a placement article object (in this example, a panel), each player can place only one placement article object. Therefore, in a case where one player places a panel a plurality of times in the same stage room, the panel placed at the last time is deleted and only the latest panel is displayed. In addition, the placement article object that was once placed continues being left in the stage even after the player who placed the placement article object has exited the stage room, as long as the stage room remains.

### Available Player Characters

In this game, as a character that can be used as a player character, a plurality of different kinds of characters are prepared in advance and a character is selected therefrom to play. Such different kinds of characters are characters of which at least the appearances (outer appearances) are different to an extent that allows the player to recognize that “they are different characters”. In this game, the characters are different also in performance and the like. Hereinafter, “same characters” mean the same kind of characters, and “different characters” mean different kinds of characters.

Each player needs to select a character that the player uses, to play in this game. In the exemplary embodiment, as an example, it is assumed that twelve kinds of different characters, “character A” to “character L”, are prepared. Then, each player selects one of the twelve kinds of characters, as a player character that the player uses. Thus, as the remote character 211, a character selected by another player is displayed and a character different from the player character 201 can be displayed.

Here, in a case of online multiplay in which many unspecified players are matched, it is also assumed that different players select the same character and play in the same room, because the number of characters that can be selected is limited. In this regard, on the world map screen and the stage screen, if a plurality of characters having the same appearance are displayed, it might be difficult to recognize a target character to be operated by each player.

Considering the above, it is conceivable that players are matched while adjustment is performed so that matched characters do not coincide with each other. In this way, players who have selected the same character can be prevented from being matched together, and thus it is possible to avoid such a situation that a plurality of characters having the same appearance are displayed at the same time. However, in this case, for example, a player cannot enter a room in which the same character is present, and therefore, when a character that a player has selected coincides with that of another player, matching becomes less likely to succeed, so that a waiting time for matching becomes long.

Accordingly, in the exemplary embodiment, without performing control for restricting matching of the same characters as described above, control is performed so that two or more of the same player characters are not displayed on the game screen of the game apparatus of each player. Specifically, on each of the world map screen and the stage screen, control as shown below is performed to prevent a plurality of the same characters from being displayed at the same time.

### Character Display Control on World Map Screen

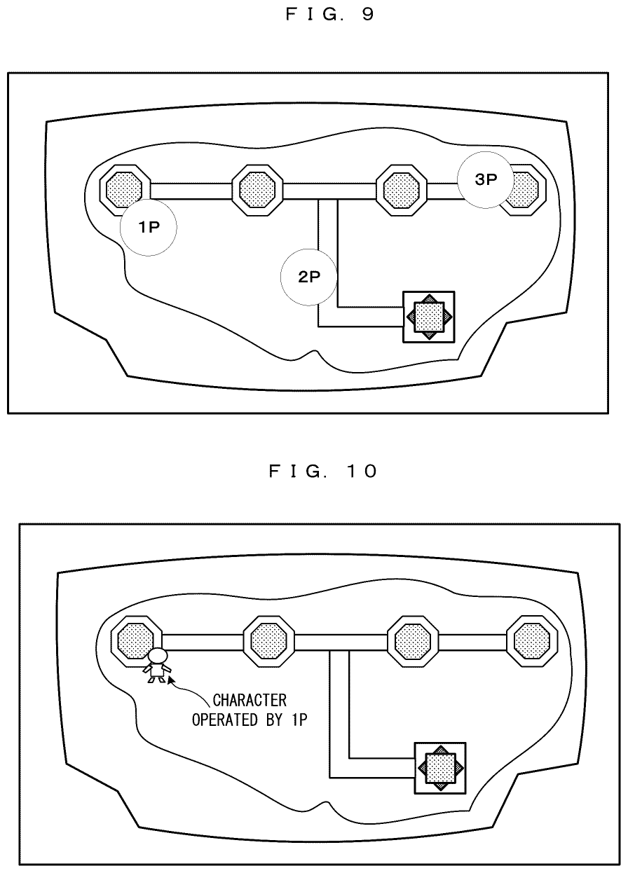

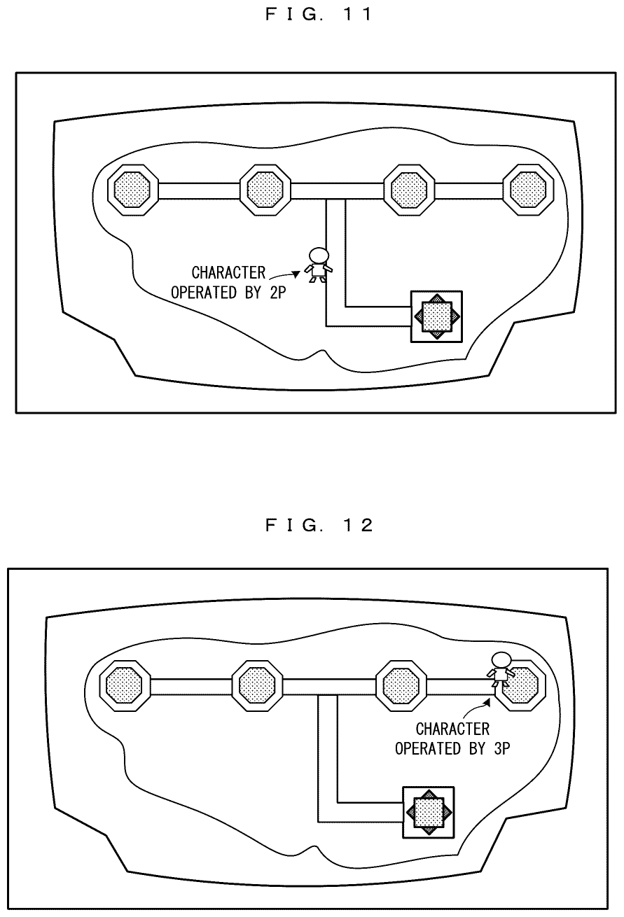

First, the outline of display control for player characters on the world map screen will be described. In the exemplary embodiment, on the world map screen, in a case where the same kind of player characters are present (coincide), control is performed so as to preferentially display only one of them on the game screen of each player. Specifically, in a case where player characters of a local player and a remote player coincide with each other, the player character (local character) of the local player is preferentially displayed. As an example, it is assumed that three players (hereinafter, they are referred to as 1P, 2P, 3P) have selected the character A. Then, it is assumed that the positions of the player characters on the world map at a given time are in a positional relationship shown in FIG. 9. In this case, since the three players have selected the same character, on the game screen of 1P (where 1P is a local player), only the character A that is an operation target of 1P is displayed as shown in FIG. 10. On the game screen of 2P (where 2P is a local player), only the character A that is an operation target of 2P is displayed as shown in FIG. 11. On the game screen of 3P (where 3P is a local player), only the character A that is an operation target of 3P is displayed as shown in FIG. 12.

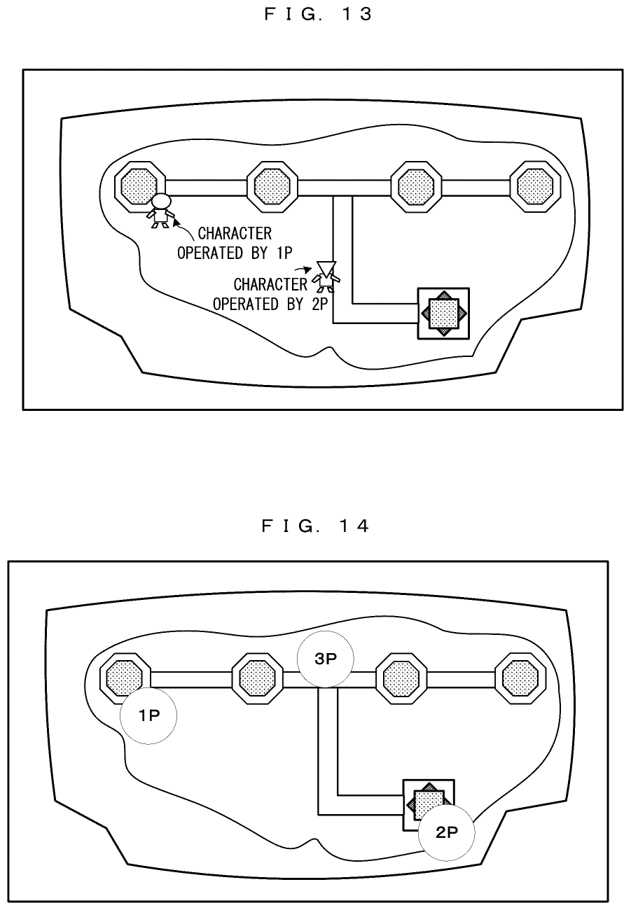

Next, it is assumed that remote characters of remote players coincide with each other while the local character does not coincide with any characters. For example, it is assumed that 1P who is the local player has selected the character A and 2P and 3P have selected the character B. In this case, on the game screen of 1P, the remote character present at the position closest to the local character, of the coinciding remote characters, is preferentially displayed. For example, under the same positional relationship as shown in FIG. 9, the character B operated by 2P, which is the closer to the local character, is displayed on the game screen of 1P, as shown in FIG. 13.

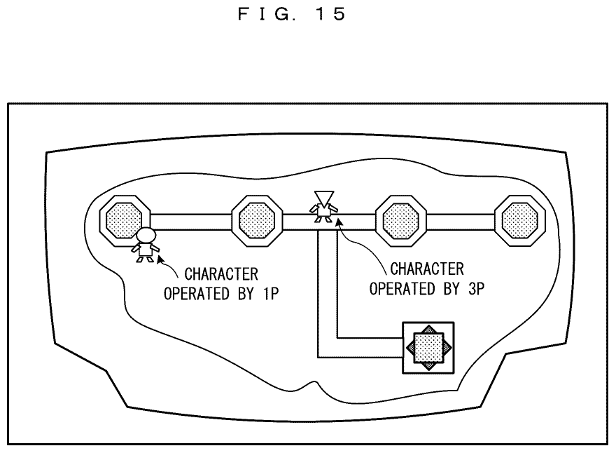

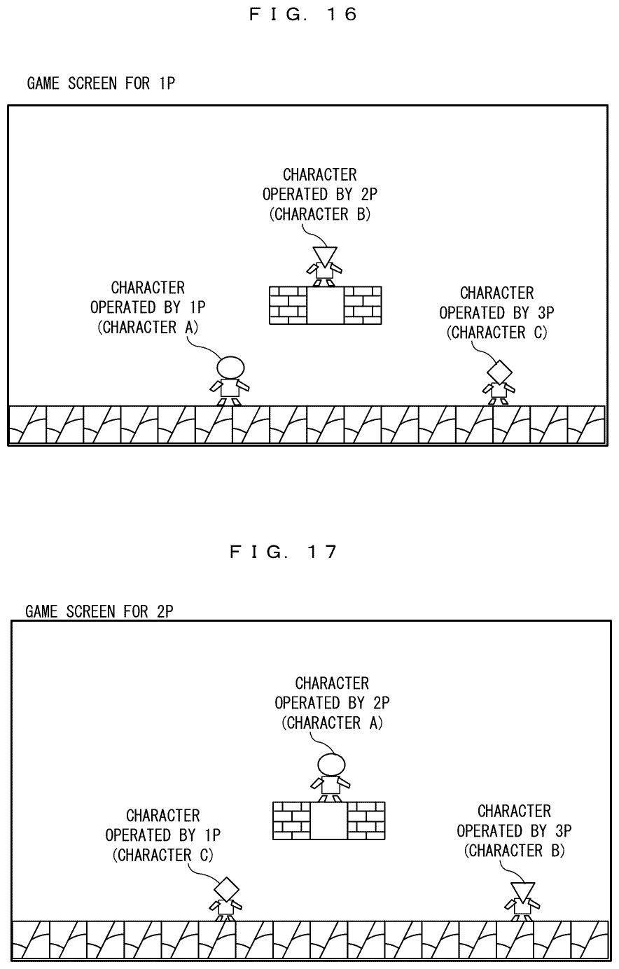

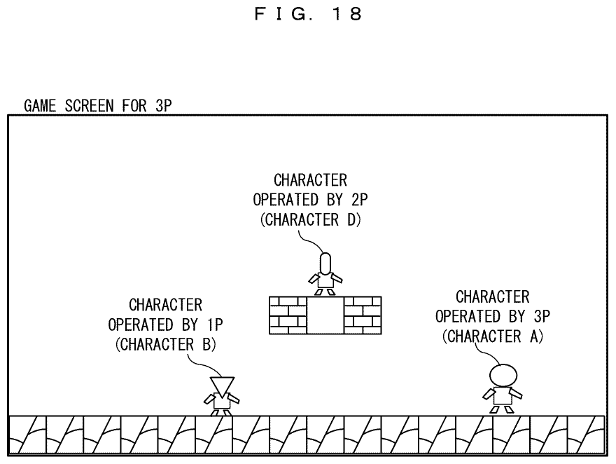

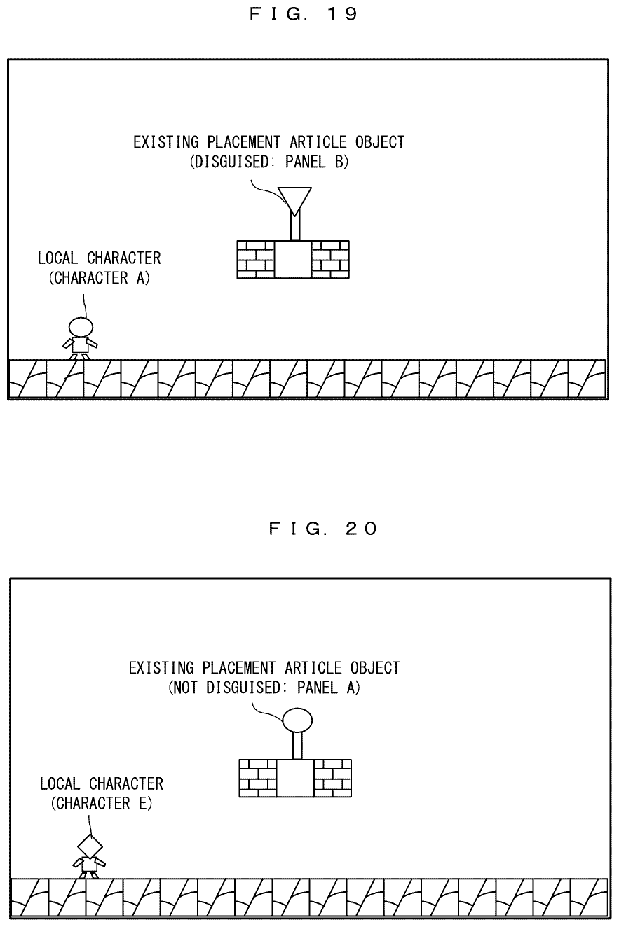

It is assumed that the positional relationship between the player characters of 2P and 3P has changed from the situation shown in FIG. 9 to a situation shown in FIG. 14. That is, it is assumed that the player character of 3P comes close to the player character of 1P and the player character of 2P moves away from the player character of 1P. In this case, as shown in FIG. 15, the character B operated by 3P, which has become closer to the local character, is displayed, and the character B operated by 2P is not displayed.

As described above, in the exemplary embodiment, in a case where a plurality of the same characters are present in the same world room, control is performed so that only one of them is displayed and a plurality of the same characters are not displayed. Therefore, irrespective of the actual number of persons who are in the room, the maximum number of player characters displayed on the world map screen is twelve (total number of different characters). In this example, since a character is selected from twelve characters, the maximum number of displayed characters is twelve, but in a case where there are a larger number of characters that can be selected, the maximum number of characters displayed on the world map screen also becomes the same as the number of characters that can be selected.

In the exemplary embodiment, in such a situation that coinciding remote characters are present on the world map screen, control is performed so that the remote character closest to the position of the local character is preferentially displayed. Here, in order to determine whether a character is closest to the position of the local character, processing of determining the distance between the local character and each of coinciding remote characters is performed. In the exemplary embodiment, the distance determination is performed at predetermined time intervals (e.g., every several seconds). That is, even if the positional relationship between the local character and the coinciding remote characters has changed, this is not necessarily reflected in real time in switchover of the remote character to be preferentially displayed. This is for preventing switchover of the remote character to be displayed from occurring highly frequently. If switchover occurs highly frequently, remote characters appear in a blinking manner, for example, so that the player feels strangeness or feels it difficult to see the screen. Such trouble is prevented by the above method.

Further, in the exemplary embodiment, in performing the distance determination described above, the actual distance between the local character and the remote character that is being preferentially displayed is corrected to be shorter. For example, it is assumed that both of 2P and 3P have selected the character B and the character B of 2P is a preferential display target. Then, it is assumed that the in-game distance between the characters of 1P and 2P is 10 m and the in-game distance between the characters of 1P and 3P is 12 m. In this case, in performing the distance determination described above, the distance between the character of 1P and the character of 2P which is being preferentially displayed is corrected to, for example, 70%. That is, the distance determination is performed with the distance corrected from 10 m to 7 m. Thus, the character B of 3P which is not a display target becomes less likely to be selected as a preferential display target. In particular, in a case where the difference between the distances of the characters of 2P and 3P is small, display of the character that is currently displayed is continued by the above correction, whereby switchover of the remote character to be displayed is prevented from occurring highly frequently.

In addition, in the exemplary embodiment, in a case where no operation has been performed on a remote character for a certain period, display of the remote character is ended even if the remote character is a preferential display target. This is for preferentially displaying the remote character that is currently being operated, rather than displaying the remote character that is left without being operated. The local character is always displayed irrespective of presence/absence of operation.

### Character Display Control in Stage Room

Next, display control for player characters and the like in the stage room will be described. In a case of the stage room, unlike the case of the world room, a coinciding player character is displayed with its image replaced (changed) with an image of another character so that the same player characters are not displayed. Hereinafter, the replacement of an image is referred to as “disguise”. In the case of the stage room, unlike the case of the world room, the maximum number of room entry persons is four and thus is comparatively small. Therefore, if a coinciding character is not displayed, such a sense of online multiplay that the player is playing with other players is lost.

The disguise processing is individually performed on each game apparatus. That is, the disguise contents are not synchronized among the game apparatuses belonging to the stage room. Therefore, the disguise contents can differ among the game apparatuses. Targets to be disguised are a remote character, a replay ghost, and a replacement article object. The disguise processing is performed at a timing when each game apparatus 3 generates a remote character. Specifically, such timings are when a local player has newly entered the stage room (if a remote player is already present, a remote character thereof is generated) and when another remote player has entered after that. In the following description, a character actually selected by each player (character before disguise) is referred to as “actual selected character”, and a character that has been disguised is referred to as “disguised character”.

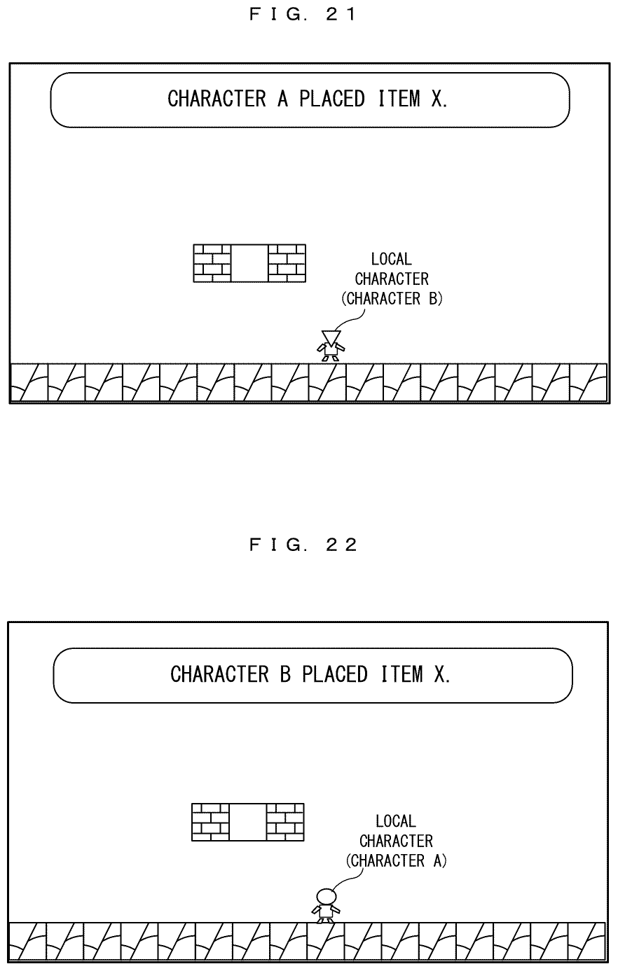

Hereinafter, examples of the disguise will be described. First, it is assumed that three players have entered one stage room and all the players have selected the character A. That is, it is assumed that there are remote players whose actual selected characters coincide with that of the local player. In this case, on the game apparatus of each player, remote characters operated by remote players are displayed in states of being disguised as characters other than the character A. Accordingly, on the game screen for 1P who is a local player, a screen as shown in FIG. 16 can be displayed. In FIG. 16, a character operated by 1P is the character A, a character operated by 2P is disguised as the character B, and a character operated by 3P is disguised as the character C. That is, as the character (local character) operated by 1P, the actual selected character is displayed, and as the remote characters of 2P and 3P, the disguised characters are displayed, instead of the actual selected characters. In the same situation, on the game screen for 2P (where 2P is a local player), a screen as shown in FIG. 17 is displayed. In FIG. 17, a character operated by 2P is the character A, a character operated by 1P is disguised as the character C, and a character operated by 3P is disguised as the character B. In the same situation, on the game screen for 3P, a screen as shown in FIG. 18 is displayed. In FIG. 18, a character operated by 3P is the character A, a character operated by 1P is disguised as the character B, and a character operated by 2P is disguised as the character D.

In a case where 2P whose actual selected character is the character A has entered a stage room and thereafter 1P whose actual selected character is also the character A enters the stage room, on the game screen for 1P, a character operated by 2P is disguised as a character other than the character A. On the other hand, on the game screen for 2P, a character operated by 1P is disguised as a character other than the character A.

### Coincidence Between Remote Players

Next, a case where there are coinciding actual selected characters only among remote players is assumed. In this case, a remote character of one of the remote players whose actual selected characters coincide with each other remains the actual selected character, and remote characters of the other remote players are disguised. For example, it is assumed that, in a stage room in which four players are present, the actual selected character of 1P is the character A, and the actual selected characters of 2P, 3P, and 4P are the character B. In this case, on the game screen of 1P, for example, a remote character of 2P is displayed so as to remain the character B, and remote characters of 3P and 4P are disguised as the character C and the character D. Thus, a situation in which two or more of the same characters are displayed at the same time is avoided.

Once a character is disguised, even if coincidence of characters is eliminated after that, the disguised state is not changed in the same stage. For example, it is assumed that the actual selected characters of 2P and 3P are the character B, and a character operated by 3P is disguised as the character C. In this case, even if 2P reaches a goal and exits the stage room and thus coincidence of the actual selected characters of 2P and 3P is eliminated, the disguise for 3P continues as it is.

### Determination of Disguise Destination

Here, how to determine the disguise content (disguise destination) will be explained. In the exemplary embodiment, data called a “disguise list” is defined in advance. In the disguise list, IDs of the twelve characters are arranged in a predetermined order. In determining the disguise destination, through processing on each game apparatus, the disguise list is referred to and the IDs are checked along the order in the list. Then, the character that does not coincide with any of the existing characters in the room and that has been found first, is determined to be a disguise destination. In checking the IDs in the disguise list, an ID as a start point (initial candidate of disguise destination) is randomly determined when the game application in the exemplary embodiment is started on each game apparatus.

### Disguise of Replay Ghost

Targets to be disguised include a replay ghost, as described above. Disguise of a replay ghost is the same as in the case of a remote player. That is, a replay ghost is treated as a remote player (remote character). For example, it is assumed that the actual selected character of a player is the character A and replay data downloaded from the game server 1 is the one in which the character A is used. In this case, the outer appearance of a replay ghost to be displayed is disguised as a character other than the character A, but the operation content of the replay ghost is based on the downloaded replay data (replay data in which the character A is used).

### Disguise of Placement Article Object

Next, disguise of a placement article object will be described. As described above, placement article objects in this game include objects whose functions or effects are the same but whose outer appearances are designed so as to respectively correspond to the twelve characters (e.g., panels described above). The placement article object once placed remains being left in the stage even after a player who placed the placement article object exits the stage room. For example, regarding the panel, it is assumed that 3P who plays using the character A places the panel A corresponding to the character A, and then clears the stage and exits the stage room. Thereafter, 1P who has selected the character A as an actual selected character may enter the same stage room (there are no coinciding actual selected characters). In this case, for 1P, the panel A that 1P does not remember placing is already present. Considering such a situation, in the exemplary embodiment, the following processing is performed: when a player has entered a stage room, if a character corresponding to a placement article object already existing in the room coincides with the actual selected character (local character) of the player, the already existing placement article object is disguised as a placement article object corresponding to another character. For example, in a case where 1P who has selected the character A as an actual selected character has entered a room in which the panel A placed by the character A is present, on the game screen for 1P, the panel A is displayed in a state of being disguised as the panel B, as shown in FIG. 19. On the other hand, in a case where 1P who has selected a character other than the character A as an actual selected character has entered the room, the panel A is displayed without being disguised, as shown in FIG. 20.

In addition, for example, in a case where 1P whose actual selected character is the character A has entered a room in which 3P who is using the character A is present, on the game screen for 1P, the character A operated by 3P is displayed in a state of being disguised as the character C, for example. In this case, a placement article object that has been already placed or will be placed later by 3P is also disguised as a placement article object corresponding to the character C.

As in the case of the remote character (replay ghost), once the placement article object is disguised, even if coincidence of characters is eliminated after that, the disguised state is not changed.

### Disguise of In-Game Message

In this game, when a placement article object is placed, a message indicating that fact is displayed on the game screen. For example, as shown in FIG. 21, a message such as “Character A placed item X.” is displayed in a caption style. Also in other cases, when a player character has performed a predetermined action, a message using the character name thereof may be displayed. Also in such messages, disguise of a character described above is reflected. For example, it is assumed that the actual selected characters of 1P and 2P are the same character A, and a character operated by 2P is disguised as the character B in game processing on the 1P side. In this case, on the game screen for 1P, a message using the character name of the disguise destination is displayed as shown in FIG. 22. That is, in a case where a character is disguised, the character name corresponding to the disguised appearance is used for a message in processing on each game apparatus.

Next, various data used in the game apparatus 3 and the game server 1, and the details of processes performed on the game apparatus 3 and the game server 1, will be described.

### Data Used in Game Server 1

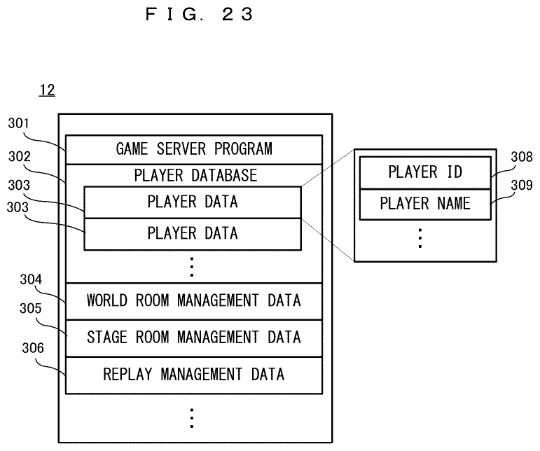

First, data used in the game server 1 will be described. FIG. 23 is a memory map showing an example of various data stored in the storage section 12 of the game server 1. The storage section 12 of the game server 1 stores at least a game server program 301, a player database 302, world room management data 304, stage room management data 305, and replay management data 306.

The game server program 301 is a program for causing the game server 1 to operate so as to implement the game processing as described above.

The player database 302 is a database about players who play the game of the exemplary embodiment. The player database 302 includes a plurality of player data 303. Each player data 303 includes a player ID 308 for identifying the player, a player name 309 of the player, and the like, for example.

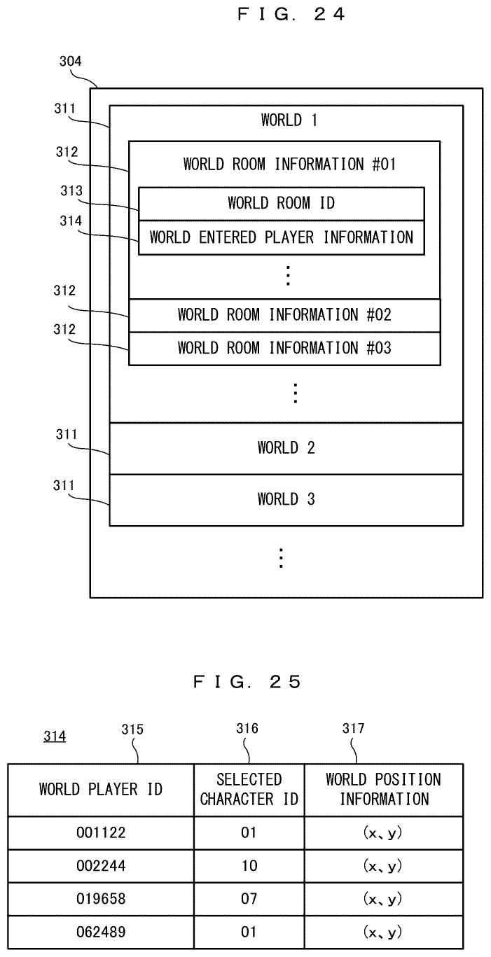

The world room management data 304 is a database for managing world rooms. FIG. 24 shows an example of the data structure of the world room management data 304. In FIG. 24, the world room management data 304 includes one or more sets of world room information 312 for each world. Each set of world room information 312 includes a world room ID 313, world entered player information 314, and the like. The world room ID 313 is an ID for uniquely identifying the world room. The world entered player information 314 is information about players who are in the world room at present. FIG. 25 shows an example of the data structure of the world entered player information 314. The world entered player information 314 is table-format data including items of a world player ID 315, a selected character ID 316, and world position information 317. The world player ID 315 is an ID of a player who is in the world room, and corresponds to the player ID 308. The selected character ID 316 is an ID for identifying a character that each player has selected as a usage character, and is information corresponding to a player character ID 421 in player character master data 404 described later. The world position information 317 is information indicating the position of the character operated by each player, in the world map.

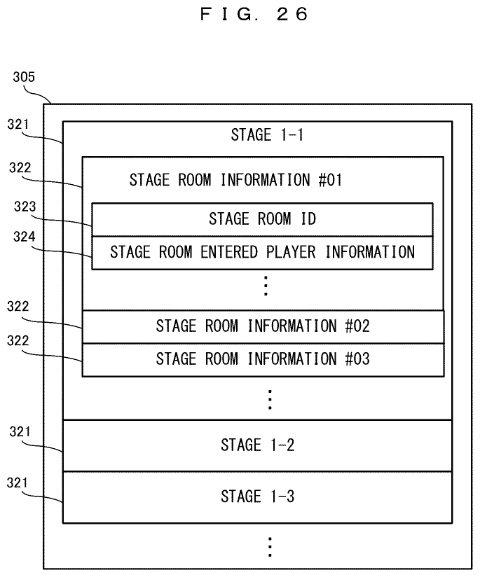

Returning to FIG. 23, the stage room management data 305 is a database for managing stage rooms. FIG. 26 shows an example of the data structure of the stage room management data 305. In FIG. 26, the stage room management data 305 includes stage room information 322 for each stage number 321 indicating each stage. A plurality of sets of the stage room information 322 can be included for one stage. Each set of stage room information 322 is information corresponding to a stage room. Each set of stage room information 322 includes a stage room ID 323, stage room entered player information 324, and the like. The stage room ID 323 is an ID for uniquely identifying the stage room. The stage room entered player information 324 is information about players who are in the stage room at present. For example, in the stage room entered player information 324, information (player ID 308) for identifying a player and information (player character ID 421) indicating an actual selected character are stored.

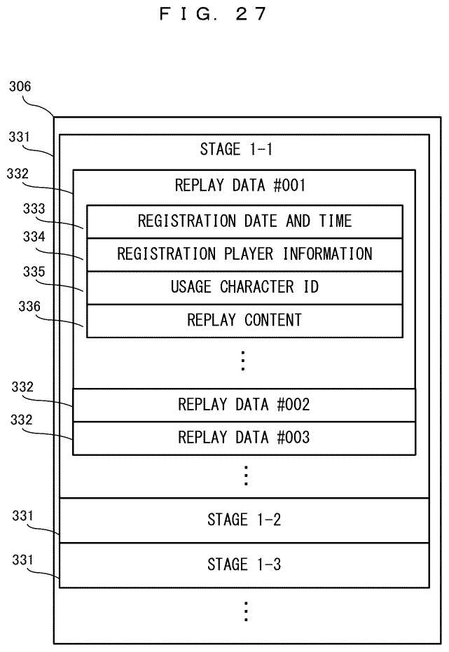

Returning to FIG. 23, next, in the replay management data 306, replay data transmitted from the game apparatus 3 as described above is stored. FIG. 27 shows an example of the data structure of the replay management data 306. The replay management data 306 includes one or more replay data 332 for each stage number 331. Each replay data 332 includes at least registration date and time 333, registration player information 334, a usage character ID 335, and a replay content 336. The registration date and time 333 indicate the date and time when the replay data was registered in the game server 1. The registration player information 334 is information indicating a player who generated the replay data. The usage character ID 335 is an ID for identifying a character used in the replay. The replay content 336 is data for representing the content of the replay. For example, the replay content 336 is data in which information indicating the position and the state of a character in the replay is arranged in time series. The replay content 336 may be, for example, key data and the like. That is, the replay content 336 may be any data content that allows the player's operation record to be recognized.

Although not shown, various data needed for performing matching processing for players, and the like, can be stored in the storage section 12 as appropriate.

### Data Used in Game Apparatus 3

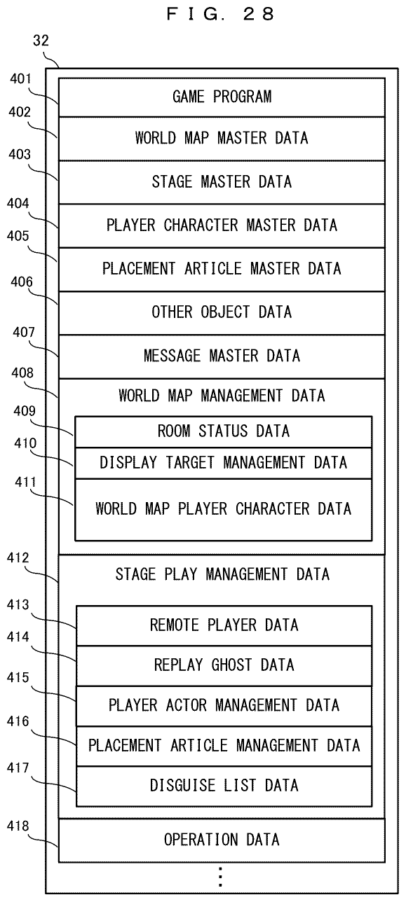

Next, data used in the game apparatus 3 will be described. FIG. 28 is a memory map showing an example of various data stored in the storage section 32 of the game apparatus 3. The storage section 32 of the game apparatus 3 stores at least a game program 401, world map master data 402, stage master data 403, player character master data 404, placement article master data 405, other object data 406, message master data 407, world map management data 408, stage play management data 412, and operation data 418.

The game program 401 is a program for the game apparatus 3 to execute the game processing in the exemplary embodiment.

The world map master data 402 is data serving as a base for world map screens. Separately for each world, the world map master data 402 includes image data of the world map screen, configuration information (number of stages, etc.) of the world, and the like.

The stage master data 403 includes data for constructing a stage to play. Specifically, the stage master data 403 includes, for each stage, data indicating position information of a start point and a goal point, and various objects, such as a midway point object, to be placed in the stage.

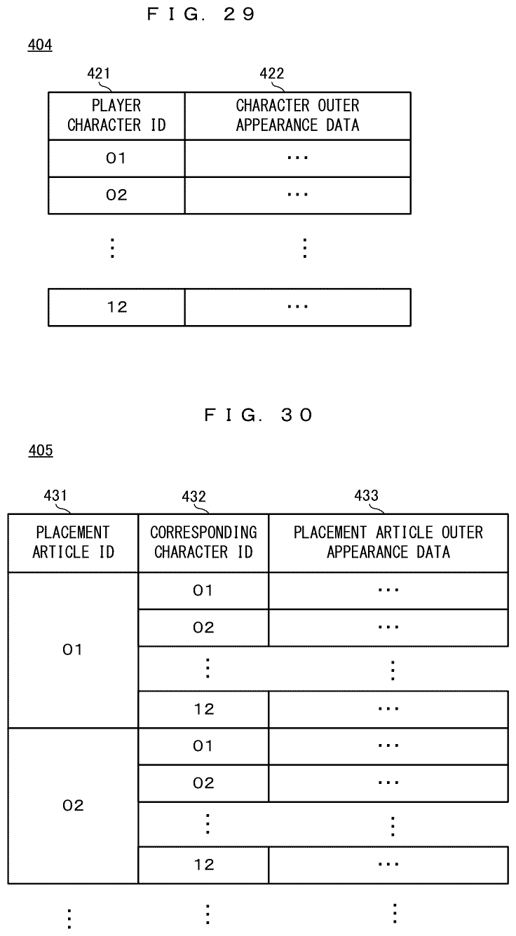

The player character master data 404 is data defining the twelve characters that can be selected as player characters. FIG. 29 shows an example of the data structure of the player character master data 404. The player character master data 404 is table-format data including at least a player character ID 421 and character outer appearance data 422. The player character ID 421 is an ID for uniquely identifying each of twelve kinds of characters. In this example, these IDs are numerical values “01” to “12”. The character outer appearance data 422 is image data indicating the outer appearance of each character. Although not shown, information defining the performance of each character, or the like may be included.

Returning to FIG. 28, next, the placement article master data 405 is master data of various placement article objects that can appear during play in stage rooms. FIG. 30 shows an example of the data structure of the placement article master data 405. The placement article master data 405 is table-format data including at least a placement article ID 431, a corresponding character ID 432, and placement article outer appearance data 433. The placement article ID 431 is an ID for identifying each placement article object that can appear in this game. The corresponding character ID 432 and the placement article outer appearance data 433 are data for indicating outer appearances prepared for respective characters, with respect to each placement article object identified by the placement article ID 431. The corresponding character ID 432 corresponds to the player character ID 421, and the placement article outer appearance data 433 is image data of outer appearances. In this example, pieces of placement article outer appearance data 433 corresponding to the twelve characters are prepared for each placement article ID 431. In the example shown in FIG. 30, it is assumed that a placement article object whose placement article ID 431 is “01” is the “panel” described above. Then, for the placement article object “panel”, different outer appearances for the respective twelve characters are prepared. In a case where each character places a panel, the character can place only a panel having an outer appearance corresponding to the character and cannot voluntarily place a panel of another character. For example, in a case where the character A places a panel, the character A cannot place a panel having an outer appearance corresponding to the character B or the character C. Although not shown, the placement article master data 405 includes also data defining actions or effects of placement articles.

Returning to FIG. 28, next, the other object data 406 is data of various objects other than the player characters and the placement article objects described above. For example, data of enemy characters and the like are included.

The message master data 407 is master data of various messages to be displayed during the game. For example, in a case of messages as shown in FIG. 21 and FIG. 22, text data such as “ChrStr placed ItemStr.” is defined in association with a message ID, in the message master data 407. Here, “ChrStr” and “ItemStr” are variables, and in actual display, the name of a character and the name of a placement article are substituted into the variables.

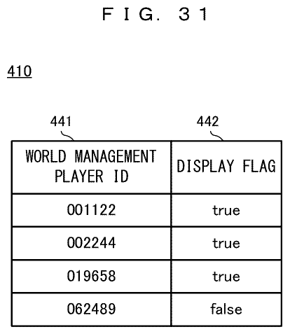

The world map management data 408 is data for management used when processing for a world map screen is executed on the game apparatus 3. The world map management data 408 includes at least room status data 409, display target management data 410, and world map player character data 411. As the room status data 409, the world room information 312 corresponding to a world room that the player has entered is acquired from the game server 1 and then is stored. The display target management data 410 is data to be used for display control for coinciding characters as described above. FIG. 31 shows an example of the display target management data 410. The display target management data 410 includes a world management player ID 441 and a display flag 442. The world management player ID 441 is data corresponding to the world player ID 315 in the world entered player information 314 included in the world room information 312 acquired from the game server 1. The display flag 442 is a flag indicating whether or not to display a character corresponding to each player. If the display flag 442 is true, the character is displayed, and if the display flag 442 is false, the character is not displayed.

Returning to FIG. 28, the world map player character data 411 is information about a player character to be displayed on the world map screen. The world map player character data 411 includes the player character ID 421 of a character that is being used, position information thereof on the world map, and the like.

Next, the stage play management data 412 is data for management used when processing for stage play is executed on the game apparatus. The stage play management data 412 includes at least remote player data 413, replay ghost data 414, player actor management data 415, placement article management data 416, and disguise list data 417.

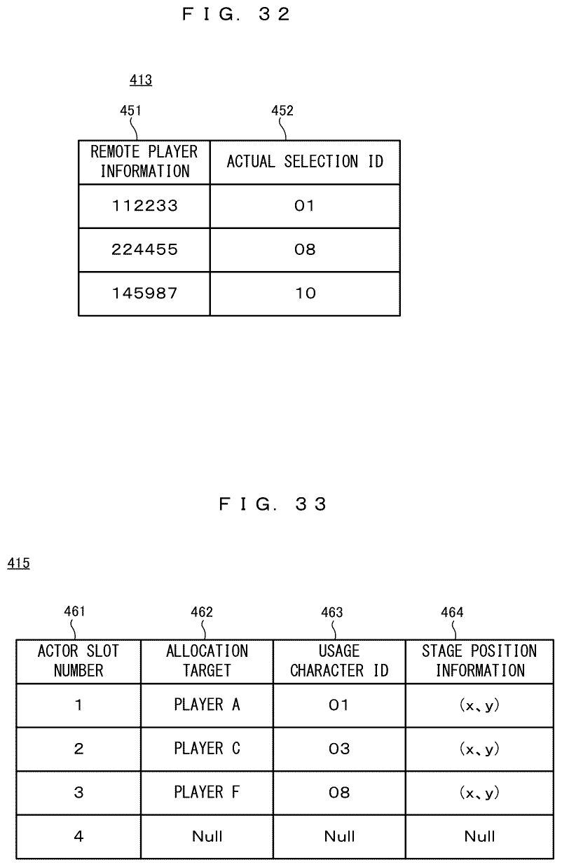

The remote player data 413 is data for managing remote players who are in the stage room at present. FIG. 32 shows an example of the data structure of the remote player data 413. The remote player data 413 is table-format data including items of remote player information 451 and an actual selection ID 452. The remote player information 451 is information corresponding to the player ID 308 of each remote player. The actual selection ID 452 is the player character ID 421 of the actual selected character of each remote player. That is, the actual selection ID 452 indicates the player character ID 421 of any character that each remote player has selected as a player character to be used, among the twelve characters.

Returning to FIG. 28, in the replay ghost data 414, the replay data 332 acquired from the game server 1 is stored.

The player actor management data 415 is data for managing a local character, a remote character, and a replay ghost to appear in stage play. FIG. 33 shows an example of the data structure of the player actor management data 415. The player actor management data 415 is table-format data including at least items of an actor slot number 461, an allocation target 462, a usage character ID 463, and stage position information 464. As described above, the number of player actors in this game is four at maximum. Therefore, the player actor management data 415 is also configured as data for four player actors. The actor slot number 461 indicates numbers (actor slots) for management of four player actors. The allocation target 462 is data indicating a target allocated to each actor slot. In this example, information indicating any player or a replay ghost is set. The usage character ID 463 corresponds to the player character ID 421 of a character displayed as each player actor. If an actual selected character does not coincide with another character and is not disguised, the player character ID 421 of the actual selected character is set. If an actual selected character coincides with another character and is disguised, the player character ID 421 of the disguised character is set. The stage position information 464 is information indicating the present position of each player actor in the stage. Although not shown, the player actor management data 415 may include an item indicating the “state” of each player actor, or the like.

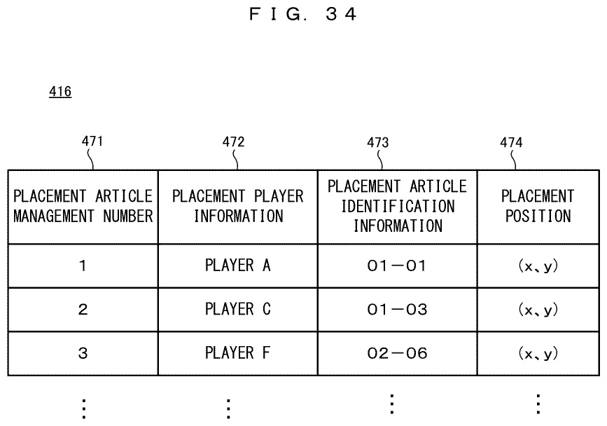

Returning to FIG. 28, next, the placement article management data 416 is data for managing placement article objects placed in the stage. FIG. 34 shows an example of the data structure of the placement article management data 416. The placement article management data 416 is table-format data including at least items of a placement article management number 471, placement player information 472, placement article identification information 473, and a placement position 474. The placement article management number 471 is a number for uniquely identifying each placement article object placed in the stage. The placement player information 472 is information indicating a player who placed each placement article. The placement article identification information 473 is information for identifying (the outer appearance of) each placement article object that has been placed. In this example, each placement article object is identified by a combination of the placement article ID 431 and the corresponding character ID 432 in the placement article master data 405. The placement position 474 is information indicating the position where each placement article object is placed in the stage.

Returning to FIG. 28, next, the disguise list data 417 is data of the disguise list described above. That is, the disguise list data 417 is list-format data in which the player character IDs 421 are arranged in a predetermined order.

The operation data 418 is data obtained from the controller 4 operated by the player. That is, the operation data 418 is data indicating the content of operation performed by the player.

In addition, although not shown, various data needed for the game processing,

e.g., transmission data which are various data to be transmitted to the game server 1 and another game apparatus 3 and reception data received from another game apparatus 3, are generated as necessary, and then are stored in the storage section 32.

Next, the details of the game processing in the exemplary embodiment will be described. Here, processing regarding display control for coinciding characters as described above will be mainly described, and the detailed description of other parts of the game processing is omitted. In the exemplary embodiment, one or more processors read and execute the programs stored in one or more memories, thereby implementing flowcharts shown below. The flowcharts shown below are merely an example of a processing procedure. Therefore, the processing order of steps may be changed as long as the same result is obtained. In addition, values of variables and thresholds used in determination steps are also merely an example, and other values may be employed as necessary.

### Details of Processing Executed by Processor 31 of Game Apparatus 3

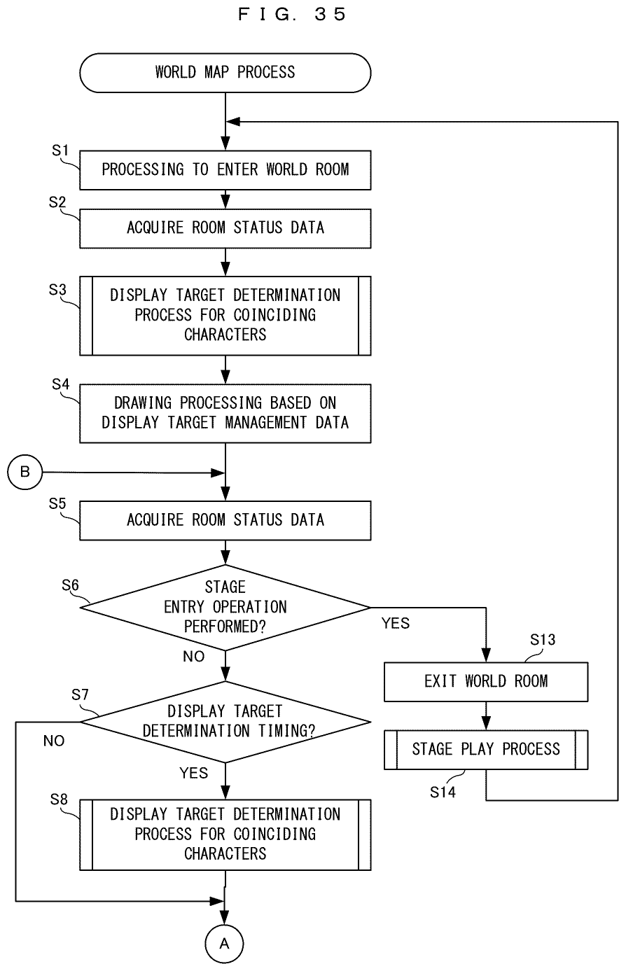

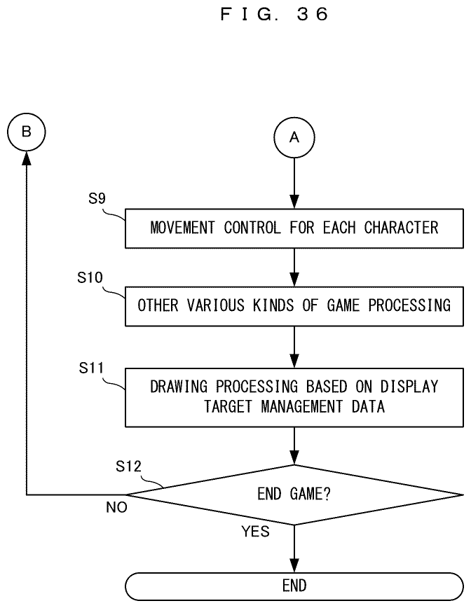

FIG. 35 and FIG. 36 are flowcharts showing the details of a world map process executed by the processor 31 of the game apparatus 3. This process is performed on the world map screen described above.

In the game apparatus 3, when the game is started by the player, first, in step S1, the processor 31 executes processing to enter a world room. In this processing, connection processing to the game server 1 is performed, and then processing for causing the player to select a character to be used as a player character is executed. After a character to be used is selected, processing of determining a world room to be entered (matching processing) is performed. Then, processing of entering the determined world room, i.e., processing of establishing a session with a communication group corresponding to the world room, is executed.

Next, in step S2, the processor 31 acquires the world room information 312 corresponding to the entered world room from the game server 1 and stores the world room information 312 as the room status data 409.

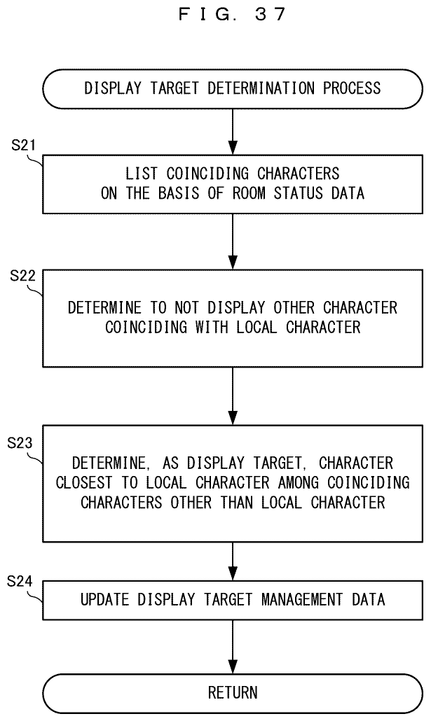

Next, in step S3, the processor 31 executes processing for determining a display target for coinciding characters in the world room (display target determination process). FIG. 37 is a flowchart showing the details of the display target determination process. In FIG. 37, first, in step S21, the processor 31 lists player characters coinciding with each other in the world room, on the basis of the room status data 409. Here, the processor 31 excludes a remote character (left character) that has not been operated for a certain period or longer, from targets of the listing. Therefore, as a result of the listing, a list in which such a left character is not included is generated.

Next, in step S22, the processor 31 determines to not display a player character coinciding with the local character. That is, the processor 31 determines to preferentially display the local character.

Next, in step S23, in a case where there are coinciding characters other than the local character, the processor 31 determines, as a preferential display target, a player character present at a position closest to the local character among the coinciding characters. Here, as described above, for the character that is currently displayed, the distance to the local character in the world map is corrected to be shorter than the actual distance, to perform determination for the distance to the local character.

Next, in step S24, the processor 31 reflects the content of the determination in the display target management data 410. That is, for players of characters that have not been determined as a preferential display target among players whose characters coincide with each other, the display flags 442 are set to false, and for the other players, the display flags 442 are set to true. In addition, the processor 31 performs setting so that the left character as described above is not displayed. Thus, the display target determination process is ended.

Returning to FIG. 35, next, in step S4, the processor 31 places the local character at a predetermined initial position in the world map. Then, the processor 31 draws a world map screen on the basis of the display target management data 410. As a result, regarding coinciding characters, only one of them is displayed on the outputted world map screen. This screen is the world map screen in a state just after entry into the world room.

Next, in step S5, the processor 31 acquires the world room information 312 from the game server 1 and stores the world room information 312 as the room status data 409. That is, the status of the world room is updated to the latest information.

Next, in step S6, the processor 31 determines whether or not an operation of giving an instruction to start play in a predetermined stage (stage entry operation) is performed, on the basis of the operation data 418. As a result of the determination, if the operation has not been performed (NO in step S6), in step S7, the processor 31 determines whether or not a timing of executing the display target determination process has come. As described above, in the exemplary embodiment, from the standpoint of preventing switchover of a character to be displayed from occurring highly frequently, the display target determination process is executed at intervals of several seconds, instead of in real time. Therefore, here, the timing is set to come at intervals of several seconds. As a matter of course, the timing can be arbitrarily set and may be any timing that is in accordance with the above standpoint. As a result of the determination, if the timing of executing the display target determination process has come (YES in step S7), in step S8, the processor 31 executes the display target determination process as described above. On the other hand, if the timing of executing the display target determination process has not come yet (NO in step S7), the processing in step S8 is skipped.

Next, in step S9 in FIG. 36, the processor 31 performs movement control for each player character in the world map, on the basis of the operation data 418 and the room status data 409.

Next, in step S10, the processor 31 executes various kinds of game processing other than the above processing, as necessary.

Next, in step S11, the processor 31 draws a world map screen on the basis of the display target management data 410.

Next, in step S12, the processor 31 determines whether or not a condition for ending the game is satisfied. If the condition is not satisfied (NO in step S12), the processor 31 returns to step S5, to repeat the process. If the condition is satisfied (YES in step S12), the processor 31 ends the world map process.

Next, processing in a case where the stage entry operation has been performed as a result of the determination in step S6, will be described. In this case, in step S13, the processor 31 performs processing of exiting the world room.

Next, in step S14, the processor 31 executes a stage play process. After the stage play process is ended, the processor 31 returns to step S1, to repeat the process.

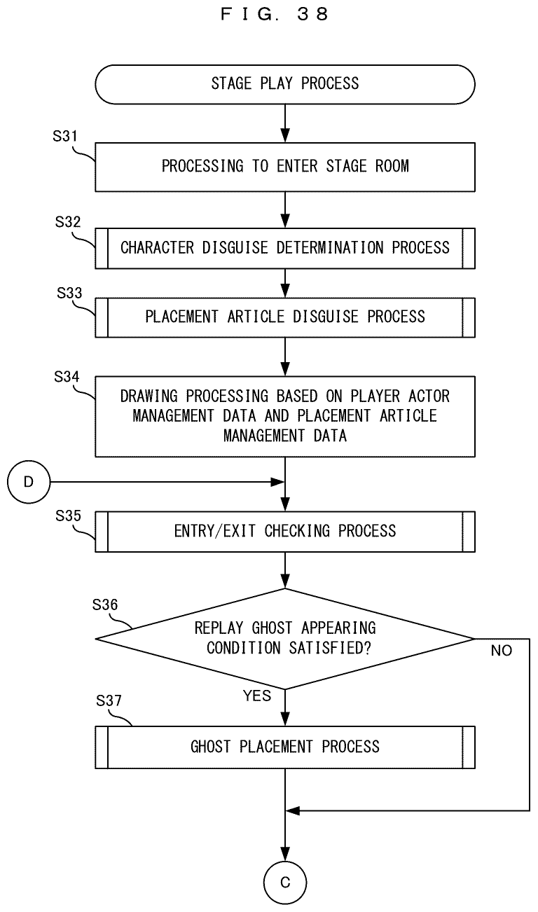

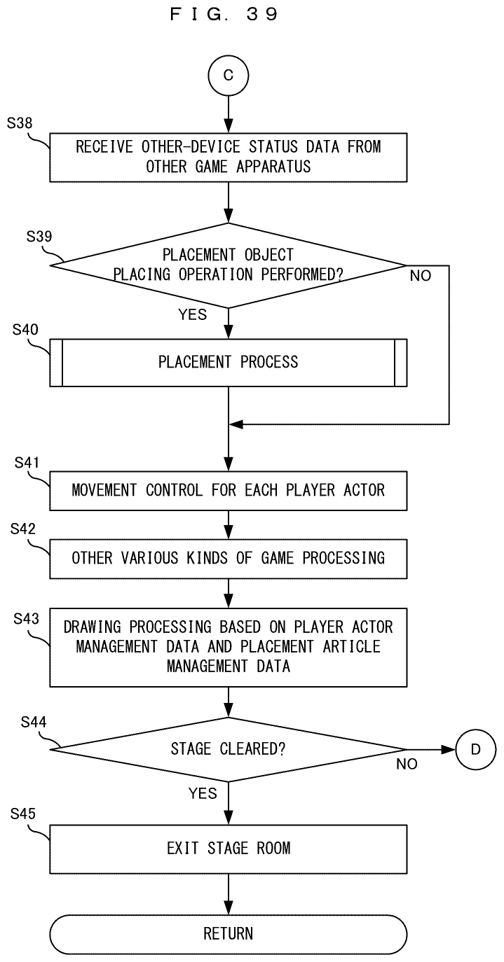

Next, the details of the stage play process will be described. FIG. 38 and FIG. 39 are flowcharts showing the details of the stage play process. First, in step S31, the processor 31 executes processing to enter a stage room. Specifically, first, the processor 31 requests the game server 1 to perform matching processing. Then, the processor 31 executes processing to enter a stage room determined on the basis of the matching result. At this time, in a case of entering an already existing room, various kinds of information indicating the status of the room are received from another game apparatus 3 of any player who has already entered. For example, information about a remote player who has already entered, a replacement article object that is placed, and the like is received. Then, on the basis of the received information, the remote player data 413, the player actor management data 415, and the placement article management data 416 are generated as appropriate. In addition, the processor 31 transmits information about a character that the player uses as a player character, to the game apparatus 3 of the player who has already entered. In a case of newly generating a room and entering the room instead of entering an already existing room, reception of various kinds of information indicating the status of the room and the generation processing based on the received information as described above are not needed.

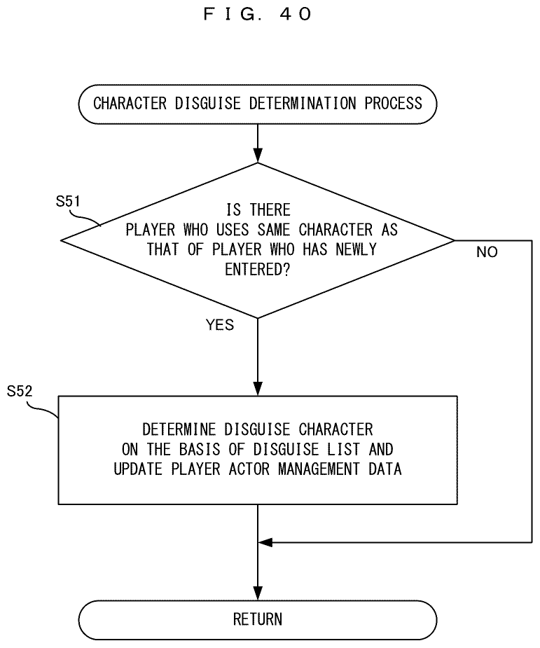

Next, in step S32, the processor 31 executes a character disguise determination process. FIG. 40 is a flowchart showing the details of the process. First, in step S51, the processor 31 determines whether or not there is a player whose actual selected character is the same as that of a player who has newly entered the stage room. In a case where a local player has newly entered the stage room, the local player corresponds to the above “player who has newly entered the stage room”. In a case where a local player has entered and then a remote player has newly entered, the remote player corresponds to the above “player who has newly entered the stage room”. As a result of the determination, if there is a player whose actual selected character is the same as that of a player who has newly entered the stage room (YES in step S51), in step S52, the processor 31 determines a character that is a disguise destination, on the basis of the disguise list described above. That is, the processor 31 goes through the list in an order from the character that is the start point described above, to search for a character that does not coincide with the player character already existing in the stage room. Then, the processor 31 determines a character that does not coincide and has been found first, as a disguise destination, and updates the player actor management data 415 on the basis of the content of the determination. Specifically, in a case where a local player has newly entered the stage room, the processor 31 performs disguise setting for data regarding a remote player who has already entered. Specifically, the player character ID 421 determined as a disguise destination is set for the usage character ID 463 in the player actor management data 415 corresponding to the remote player whose actual selected character is the same as that of the local player. In addition, if there are a plurality of remote players whose actual selected characters are the same as that of the local player, disguise destinations are determined so that characters do not coincide with each other also among the remote players. In a case where a remote player has newly entered, the player character ID 421 determined as a disguise destination is set for the usage character ID 463 in the player actor management data 415 corresponding to the remote player who has newly entered. That is, the character operated by the remote player who has joined later is disguised.

In a case where a remote player has newly entered, a disguise destination may be determined in consideration of not only already existing player characters but also already existing placement article objects. Alternatively, a disguise destination may be determined so as to avoid only coincidence with already existing player characters, without particularly considering already existing placement article objects.

On the other hand, as a result of the above determination, if there is no player whose actual selected character is the same as that of the player who has newly entered the stage room (NO in step S51), the processing in step S52 is skipped. Thus, the character disguise determination process is ended.

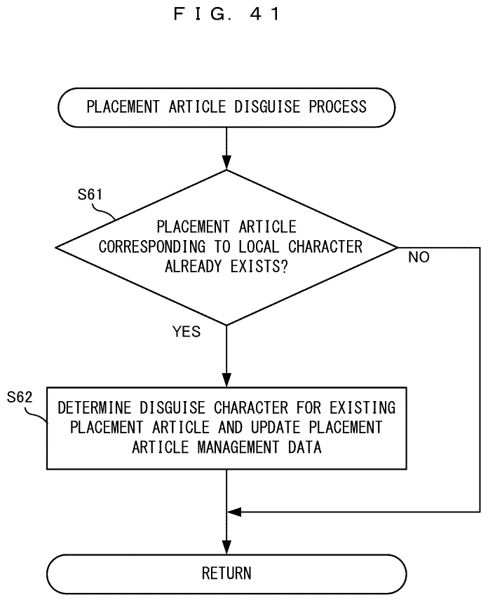

Returning to FIG. 38, next, in step S33, the processor 31 executes a placement article disguise process. FIG. 41 is a flowchart showing the details of this process. In FIG. 41, in step S61, the processor 31 determines whether or not a placement article object corresponding to a local character is present in the stage room. As a result of the determination, if such a placement article object is present (YES in step S61), in step S62, the processor 31 determines a disguise destination of the character corresponding to the already existing placement article, using the disguise list. Then, on the basis of the content of the determination, an image of the placement article corresponding to the disguise destination is determined and the placement article management data 416 is updated. Specifically, on the basis of the player character ID 421 of the disguise destination, the content (combination of placement article ID 431 and corresponding character ID 432) of the placement article identification information 473 about the corresponding placement article object in the placement article management data 416 is updated. For example, in a case where a panel corresponding to the character A is disguised as a panel corresponding to the character C, the content of the placement article identification information 473 is updated from “01-01” to “01-03”. Thus, the placement article outer appearance data 433 to be used for disguise can be determined.

On the other hand, if such a placement article object corresponding to a local character is not present in the stage room (NO in step S61), the processing in step S62 is skipped. Thus, the placement article disguise process is ended.

Returning to FIG. 38, next, in step S34, the processor 31 draws a game image according to stage play, on the basis of the player actor management data 415 and the placement article management data 416. As a result, an image of each player actor is displayed by an image of a character designated by the usage character ID 463 in the player actor management data 415. As described above, in a case of not performing disguise, the ID of the actual selected character is set for the usage character ID 463, and in a case of performing disguise, the ID of a disguised character is set. Regarding an image of an already existing placement article object, an image based on the placement article outer appearance data 433 specified by the placement article identification information 473 in the placement article management data 416 is drawn. Also for this image, in a case of performing disguise, the placement article outer appearance data 433 corresponding to the disguised character is used.

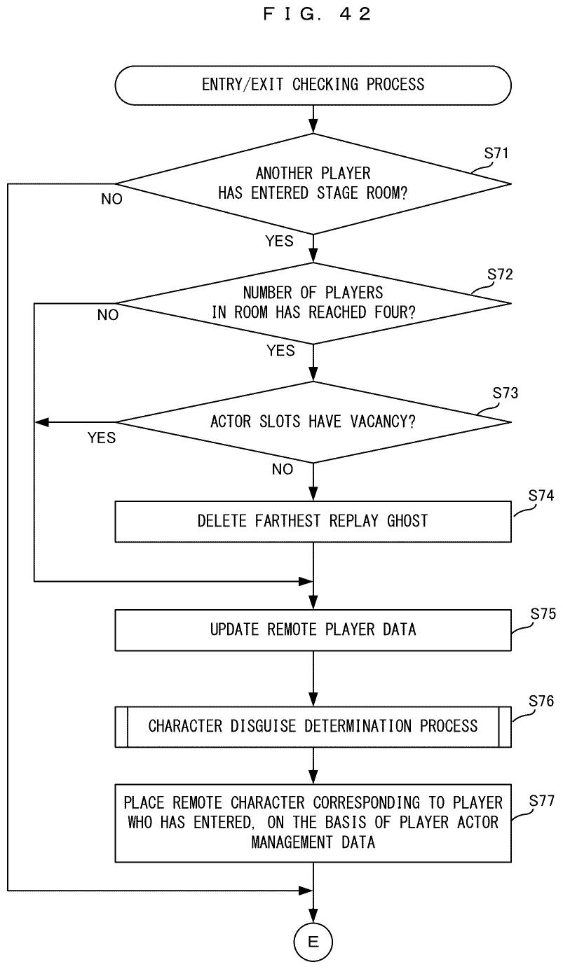

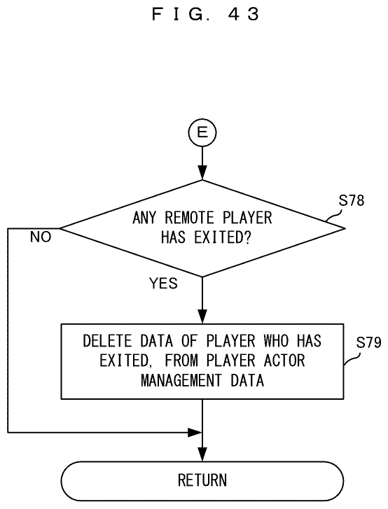

Next, in step S35, the processor 31 executes an entry/exit checking process. This is a process for checking entry and exit of another player after entry of the local player. FIG. 42 and FIG. 43 are flowcharts showing the details of the entry/exit checking process. First, in step S71, the processor 31 determines whether or not a new remote player has entered. As a result of the determination, if no new remote player has entered (NO in step S71), the processor 31 proceeds to step S78 described later. On the other hand, if a new remote player has entered (YES in step S71), next, in step S72, the processor 31 determines whether or not the number of players in the room has reached four. As a result of the determination, if the number has not reached four (NO in step S72), the processor 31 proceeds to step S75 described later. On the other hand, if the number has reached four (YES in step S72), in step S73, the processor 31 refers to the player actor management data 415, to determine whether or not there is a vacancy in the slots of player actors. As a result of the determination, if there is no vacancy (NO in step S73), it is considered that there are three replay ghosts. Therefore, in step S74, the processor 31 deletes a replay ghost present at a position farthest from the local character. That is, data regarding the replay ghost are deleted from the replay ghost data 414 and the player actor management data 415. Then, the processor 31 proceeds to step S75. On the other hand, as a result of the above determination, if there is a vacancy in the slots of player actors (YES in step S73), the processing in step S74 is skipped.

Next, in step S75, the processor 31 updates the remote player data 413 on the basis of information received from the game apparatus of the remote player who has entered. In addition, the processor 31 updates the player actor management data 415 on the basis of the information. Therefore, at this time, the ID for identifying the actual selected character selected by the remote player is registered in the usage character ID 463.

Next, in step S76, the processor 31 executes a character disguise determination process. This process is the same as in step S32 and therefore the detailed description thereof is omitted. Through this process, whether or not the remote player who has newly entered needs to be disguised is determined. That is, if the actual selected character of the remote player who has newly entered coincides with a remote character or a replay ghost already existing in the stage room, setting for disguising the remote character of the remote player is performed. Specifically, as the setting, update of the player actor management data 415 as described above is performed.

Next, in step S77, the processor 31 places the remote character corresponding to the player who has entered, on the basis of the player actor management data 415.

Next, in step S78 in FIG. 43, the processor 31 determines whether or not any remote player has exited. In addition, the processor 31 determines whether or not reproduction of a replay ghost existing at this time is finished. As a result of the determination, if any remote player has exited or reproduction of a replay ghost is finished (YES in step S78), in step S79, the processor 31 deletes data of a remote character of the player who has exited, from the player actor management data 415, or the processor 31 deletes data of the replay ghost of which reproduction is finished, from the player actor management data 415.

On the other hand, if no remote player has exited and finish of reproduction of a replay ghost has not occurred (NO in step S78), the processing in step S79 is skipped. Then, the processor 31 ends the entry/exit checking process.

Returning to FIG. 38, next, in step S36, the processor 31 determines whether or not a condition for causing a replay ghost to appear is satisfied. In this example, the condition is determined to be satisfied in a case where the player character has advanced to the midway point in a state in which only one local player is present in the stage room as described above. As a result of the determination, if the condition is not satisfied (NO in step S36), the processor 31 proceeds to step S38 described later. On the other hand, if the condition is satisfied (YES in step S36), in step S37, the processor 31 executes a ghost placement process.

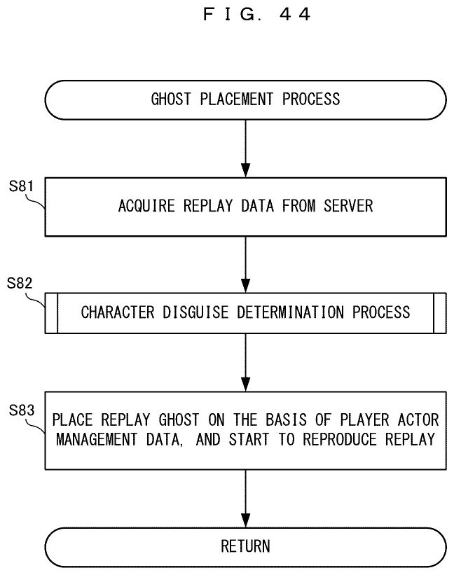

FIG. 44 is a flowchart showing the details of the ghost placement process. First, in step S81, the processor 31 acquires replay data regarding the stage in which play is currently being performed, from the game server 1. The content of the replay data to be acquired may be any content. For example, replay data randomly selected in the game server 1 is acquired. Here, it is assumed that replay data for three characters are acquired. Then, on the basis of the replay data, the processor 31 registers information about replay ghosts in the player actor management data 415.

Next, in step S82, the processor 31 executes the character disguise determination process. Here, the character disguise determination process is executed with the above acquired replay data regarded as a remote player who has newly entered. Therefore, if the character used in the acquired replay data is the same as the local character, setting for causing a disguised replay ghost to appear is performed.

Next, in step S83, the processor 31 places the replay ghost in the stage on the basis of the player actor management data 415. Then, the processor 31 starts to reproduce the replay ghost. Thus, the replay ghost appears in the stage. Thus, the ghost placement process is finished.

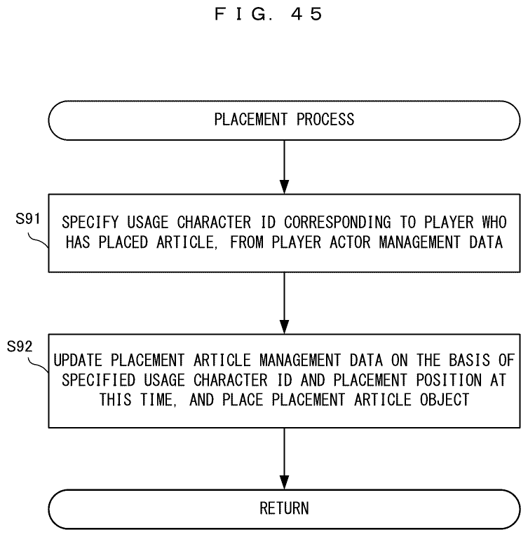

Next, in step S38 in FIG. 39, the processor 31 receives other-device status data indicating the operation content of a remote player and the like from another game apparatus 3 belonging to the same stage room. Next, in step S39, the processor 31 determines whether or not any player has performed an operation of placing a placement article object, on the basis of the operation data 418 and the other-device status data received from another game apparatus. As a result of the determination, if the placement operation has been performed (YES in step S39), in step S40, the processor 31 executes a placement process. FIG. 45 is a flowchart showing the details of the placement process. In FIG. 45, first, in step S91, the processor 31 acquires the usage character ID 463 corresponding to the player who has performed the placement operation, from the player actor management data 415. Next, in step S92, the processor 31 determines the content of the placement article identification information 473 in the placement article management data 416, on the basis of the placement article ID 431 indicating the placement article object corresponding to the placement operation and the acquired usage character ID 463. Then, the processor 31 updates the placement article management data 416, using the determined content of the placement article identification information 473 and information about the newly designated placement position. Thus, in a case where a disguised character has placed a placement article, a placement article object corresponding to the disguised character is placed. Thus, the placement process is ended.

Returning to FIG. 39, as a result of the determination in step S39, if such a placement operation has not been performed (NO in step S39), the processing in step $40 is skipped.

Next, in step S41, the processor 31 performs movement control for each player actor on the basis of the operation data 418, the other-device status data, and the replay data. Next, in step S42, the processor 31 performs various other kinds of game processing. Specifically, collision detection for various objects and processing based on a result of the collision detection are performed. In addition, as processing relevant thereto, a message as described above is displayed as appropriate on the basis of the message master data 407. At this time, in a case where a character name is used in the message, the character name is determined on the basis of the usage character ID 463 in the player actor management data 415. Therefore, the message is displayed with the disguise content of the character reflected therein.

Next, in step S43, the processor 31 performs processing of drawing a game image on the basis of the player actor management data 415, the placement article management data 416, and a result of the above various kinds of game processing.

Next, in step S44, the processor 31 determines whether or not the local character has cleared the stage. As a result of the determination, if the local character has not cleared the stage yet (NO in step S44), the processor 31 returns to step S35, to repeat the process. On the other hand, if the local character has cleared the stage (YES in step S44), in step S45, the processor 31 performs various kinds of processing accompanying the clearing of the stage, and then performs processing of exiting the stage room. Then, the stage process is ended.

Thus, the detailed description of the stage play process has finished.

### Processing in Game Server 1

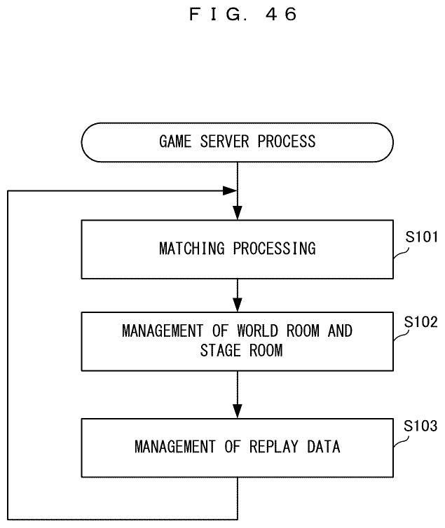

Next, the details of processing executed by the game server 1 will be described. FIG. 46 is a flowchart showing the details of the processing executed by the game server 1. In FIG. 46, first, in step S101, the processor 11 of the game server 1 executes matching processing. In this processing, in response to a matching request for a world room or a stage room from a predetermined game apparatus, matching of players, i.e., processing of determining a world room or a stage room that players are to enter, is performed. In addition, processing of transmitting the result to the game apparatus 3 is also performed.

Next, in step S102, the processor 11 performs processing of managing the world room and the stage room. In this processing, processing for managing each room, e.g., processing of generating a new room, processing of filling in with a player, and processing of deleting a room in which players are no longer present, is performed.

Next, in step S103, the processor 11 performs processing of managing replay data. In this processing, registration and update in the replay management data 306 are performed on the basis of replay data received from each game apparatus 3. In addition, in response to a request from the game apparatus 3, processing of transmitting replay data is also performed as appropriate.

Then, the processor 11 returns to step S101, to repeat the process. Thus, the detailed description of the processing executed by the game server 1 has finished.

As described above, in the exemplary embodiment, control is performed so that two or more characters of the same kind are not displayed in a multiplay game that is played with characters selected from a plurality of characters. On the world map screen, in a case where an actual selected character of a player coincides with an actual selected character of another player, the character of the other player is not displayed. In stage play, in a case where actual selected characters coincide with each other, a character operated by another player is disguised as a character other than the actual selected character so that the coinciding character is not displayed in the stage. Thus, the character operated by each player can be easily distinguished. In particular, since the character operated by each player can be easily distinguished in stage play, a phenomenon in which play by each player is hampered due to display of coinciding characters does not occur. In addition, in matching, it is not necessary to consider whether or not actual selected characters coincide with each other, and therefore there is no such case where a matching waiting state occurs due to coincidence of actual selected characters.

### Modifications

In the above exemplary embodiment, it has been described that one of the twelve characters is selected as an operation target character. In addition, also in determining a disguise destination, the disguise destination is selected from the twelve characters. In this regard, in another exemplary embodiment, the twelve characters may be classified into a plurality of types, and a disguise destination may be determined from the same type of characters. For example, among the twelve characters, six characters may be designed and classified as “human-type” characters, and other six characters may be designed and classified as “animal-type” characters. In addition, between human-type characters and animal-type characters, a difference in character performance (e.g., jump power) may be set. In this case, determination of a disguise destination in the above processing may be performed such that, if an actual selected character is a “human type”, a disguise destination is determined from the “human-type” characters, and if an actual selected character is an “animal type”, a disguise destination may be determined from the “animal-type” characters. Thus, a player is less likely to feel strangeness when seeing movement of a disguised character even in a case where there is a difference in character performance between types as described above.

A game mode in which the above-described display control is performed and a game mode in which such display control is not performed may be used. For example, in a game mode in which multiplay is performed with many unspecified players matched as described above, display control such as disguising as described above is performed. On the other hand, as a game mode in which such display control is not performed, a game mode as shown below may be used. For example, instead of matching with many unspecified players as described above, only specified players such as so-called “friends” may gather and join a communication group to perform multiplay. As another example, a plurality of players may perform multiplay using a plurality of controllers on one game apparatus, without using a network (local multiplay). In such a game mode, in selection of characters, control may be performed so as to prohibit players from selecting the same characters, and thus processing for display control as described above may not be performed. The reason is that, in this case, players can directly communicate with each other before start of play of the game, and it is possible that characters to be used by the players are directly adjusted among the players.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

What is claimed is:

1. A game system including a processor and a memory coupled thereto, and configured to perform a multiplay game among players of a plurality of game apparatuses matched via a network, the game system comprising:
a first game apparatus; and
a second game apparatus connected to the first game apparatus via the network,
the game system being configured such that
a processor of the first game apparatus selects a first player character to be subjected to movement control based on an operation by the player of the first game apparatus, from a character group including a plurality of characters different from each other,
a processor of the second game apparatus selects a second player character to be subjected to movement control based on an operation by the player of the second game apparatus, from the character group,
in a case where the selected first player character and the selected second player character are different characters,
the processor of the first game apparatus draws a game space including the first player character and the second player character, and
the processor of the second game apparatus draws a game space including the first player character and the second player character, and
in a case where the selected first player character and the selected second player character are the same character,
the processor of the first game apparatus draws a game space including the first player character without drawing the second player character, while keeping the matching between the first game apparatus and the second game apparatus, and
the processor of the second game apparatus draws a game space including the second player character without drawing the first player character, while keeping the matching between the first game apparatus and the second game apparatus.

2. The game system according to claim 1, further comprising a third game apparatus, wherein
a processor of the third game apparatus selects a third player character to be subjected to movement control based on an operation by the player of the third game apparatus, from the character group, and
in a case where the selected third player character is a character different from the first player character and is the same character as the second player character, the processor of the first game apparatus draws the game space including only one of the second player character and the third player character.

3. The game system according to claim 2, wherein
the processor of the first game apparatus draws the game space in which, of the second player character and the third player character, a character whose position in the game space is closer to the first player character is included and the other character is not included.

4. The game system according to claim 3, wherein
after the game space including only one of the second player character and the third player character is drawn, determination for a positional relationship between the first player character and each of the second player character and the third player character in the game space, is performed at predetermined-period intervals, and as a result of the determination, if a character present at a position closest to the first player character has changed, the game space in which the character present at the closest position is included and the other character is not included, is drawn.

5. The game system according to claim 2, wherein
in a case where a non-operation state in which the player of the second game apparatus or the player of the third game apparatus is not performing operation has continued for a predetermined period or longer, the processor of the first game apparatus draws the game space in which the player character of the player in the non-operation state is not included, irrespective of a positional relationship with the first player character.

6. The game system according to claim 1, wherein
the game space includes a stage space in which a first predetermined number of players are allowed to join by the matching, and a world space in which a second predetermined number of players more than the first predetermined number are allowed to join by the matching and each player is allowed to select the stage to play,
in drawing the world space on the first game apparatus, the world space including the first player character is drawn such that the second player character is not drawn, in a case where the second player character is the same as the first player character, and
in drawing the stage space on the first game apparatus, the stage space including the first player character and the second player character is drawn such that the second player character is replaced with a character different from the first player character, in a case where the second player character is the same as the first player character.

7. A computer-readable non-transitory storage medium having stored therein a game program to be executed by a processor of a game system configured to perform a multiplay game among players of a plurality of game apparatuses matched via a network, the game system including a first game apparatus and a second game apparatus connected to the first game apparatus via the network, the game program being configured to:
cause a processor of the first game apparatus to select a first player character to be subjected to movement control based on an operation by the player of the first game apparatus, from a character group including a plurality of characters different from each other;
cause a processor of the second game apparatus to select a second player character to be subjected to movement control based on an operation by the player of the second game apparatus, from the character group;
in a case where the selected first player character and the selected second player character are different characters,
cause the processor of the first game apparatus to draw a game space including the first player character and the second player character, and
cause the processor of the second game apparatus to draw a game space including the first player character and the second player character; and
in a case where the selected first player character and the selected second player character are the same character,
cause the processor of the first game apparatus to draw a game space including the first player character without drawing the second player character, while keeping the matching between the first game apparatus and the second game apparatus, and
cause the processor of the second game apparatus to draw a game space including the second player character without drawing the first player character, while keeping the matching between the first game apparatus and the second game apparatus.

8. The computer-readable non-transitory storage medium according to claim 7, the game system further including a third game apparatus, the game program being configured to:
cause a processor of the third game apparatus to select a third player character to be subjected to movement control based on an operation by the player of the third game apparatus, from the character group; and
in a case where the selected third player character is a character different from the first player character and is the same character as the second player character, cause the processor of the first game apparatus to draw the game space including only one of the second player character and the third player character.

9. The computer-readable non-transitory storage medium according to claim 8, the game program being configured to:
cause the processor of the first game apparatus to draw the game space in which, of the second player character and the third player character, a character whose position in the game space is closer to the first player character is included and the other character is not included.

10. The computer-readable non-transitory storage medium according to claim 9, the game program being configured to:
after the game space including only one of the second player character and the third player character is drawn, perform determination for a positional relationship between the first player character and each of the second player character and the third player character in the game space, at predetermined-period intervals, and as a result of the determination, if a character present at a position closest to the first player character has changed, draw the game space in which the character present at the closest position is included and the other character is not included.

11. The computer-readable non-transitory storage medium according to claim 8, the game program being configured to:
in a case where a non-operation state in which the player of the second game apparatus or the player of the third game apparatus is not performing operation has continued for a predetermined period or longer, cause the processor of the first game apparatus to draw the game space in which the player character of the player in the non-operation state is not included, irrespective of a positional relationship with the first player character.

12. The computer-readable non-transitory storage medium according to claim 7, wherein
the game space includes a stage space in which a first predetermined number of players are allowed to join by the matching, and a world space in which a second predetermined number of players more than the first predetermined number are allowed to join by the matching and each player is allowed to select the stage to play,
the game program being configured to:
in drawing the world space on the first game apparatus, cause the processor of the first game apparatus to draw the world space including the first player character such that the second player character is not drawn, in a case where the second player character is the same as the first player character; and
in drawing the stage space on the first game apparatus, cause the processor of the first game apparatus to draw the stage space including the first player character and the second player character such that the second player character is replaced with a character different from the first player character, in a case where the second player character is the same as the first player character.

13. A game processing method to be executed by a processor of a game system configured to perform a multiplay game among players of a plurality of game apparatuses matched via a network, the game system including a first game apparatus and a second game apparatus connected to the first game apparatus via the network, the game processing method being configured to:
cause a processor of the first game apparatus to select a first player character to be subjected to movement control based on an operation by the player of the first game apparatus, from a character group including a plurality of characters different from each other;
cause a processor of the second game apparatus to select a second player character to be subjected to movement control based on an operation by the player of the second game apparatus, from the character group;
in a case where the selected first player character and the selected second player character are different characters,
cause the processor of the first game apparatus to draw a game space including the first player character and the second player character, and
cause the processor of the second game apparatus to draw a game space including the first player character and the second player character; and
in a case where the selected first player character and the selected second player character are the same character,
cause the processor of the first game apparatus to draw a game space including the first player character without drawing the second player character, while keeping the matching between the first game apparatus and the second game apparatus, and
cause the processor of the second game apparatus to draw a game space including the second player character without drawing the first player character, while keeping the matching between the first game apparatus and the second game apparatus.

14. The game processing method according to claim 13, the game system further including a third game apparatus, the game processing method being configured to:
cause a processor of the third game apparatus to select a third player character to be subjected to movement control based on an operation by the player of the third game apparatus, from the character group; and
in a case where the selected third player character is a character different from the first player character and is the same character as the second player character, cause the processor of the first game apparatus to draw the game space including only one of the second player character and the third player character.

15. The game processing method according to claim 14, configured to:
cause the processor of the first game apparatus to draw the game space in which, of the second player character and the third player character, a character whose position in the game space is closer to the first player character is included and the other character is not included.

16. The game processing method according to claim 15, configured to:
after the game space including only one of the second player character and the third player character is drawn, perform determination for a positional relationship between the first player character and each of the second player character and the third player character in the game space, at predetermined-period intervals, and as a result of the determination, if a character present at a position closest to the first player character has changed, draw the game space in which the character present at the closest position is included and the other character is not included.

17. The game processing method according to claim 14, configured to:
in a case where a non-operation state in which the player of the second game apparatus or the player of the third game apparatus is not performing operation has continued for a predetermined period or longer, cause the processor of the first game apparatus to draw the game space in which the player character of the player in the non-operation state is not included, irrespective of a positional relationship with the first player character.

18. The game processing method according to claim 13, wherein
the game space includes a stage space in which a first predetermined number of players are allowed to join by the matching, and a world space in which a second predetermined number of players more than the first predetermined number are allowed to join by the matching and each player is allowed to select the stage to play,
the game program being configured to:
in drawing the world space on the first game apparatus, cause the processor of the first game apparatus to draw the world space including the first player character such that the second player character is not drawn, in a case where the second player character is the same as the first player character; and
in drawing the stage space on the first game apparatus, cause the processor of the first game apparatus to draw the stage space including the first player character and the second player character such that the second player character is replaced with a character different from the first player character, in a case where the second player character is the same as the first player character.
